(19) United States
(12) Patent Application Publication
(10) Pub. No.: US 2009/0212267 A1
(43) Pub. Date: Aug. 27, 2009

(54) SMALL PARTICLE ELECTRODE MATERIAL COMPOSITIONS AND METHODS OF FORMING THE SAME

(75) Inventors: Robert J. Dobbs, Ithaca, NY (US); Archit Lal, Ithaca, NY (US); Sandra Brosious, Vestal, NY (US)

Correspondence Address: WOLF GREENFIELD & SACKS, P.C., 600 ATLANTIC AVENUE, BOSTON, MA, 02210-2206, US

(73) Assignee: Primet Precision Materials, Inc., Ithaca, NY (US)

(21) Appl. No.: 12/342,043

(22) Filed: Dec. 22, 2008

Related U.S. Application Data
(60) Provisional application No. 61/016,452, filed on Dec. 22, 2007.
(60) Provisional application No. 61/029,260, filed on Feb. 15, 2008.

(51) Int. Cl. H01B 1/02; H01B 1/00

(52) U.S. Cl. 252/521.2; 252/500

(57) ABSTRACT

Small particles, precursors used to produce the same, and methods associated with the same are described. In some embodiments, the particles are electrode materials (e.g., such as lithium-based compounds) that may be used in electrochemical cells including batteries.

### RELATED APPLICATIONS

This application claims priority to U.S. Provisional Patent Application Ser. No. 61/016,452, filed Dec. 22, 2007 and U.S. Provisional Patent Application Ser. No. 61/029,260, filed Feb. 15, 2008, both of which are incorporated herein by reference in their entireties.

### FIELD OF INVENTION

The invention relates generally to small particles, precursors used to produce the same, and methods associated with the same. In some embodiments, the particles are electrode materials (e.g., such as lithium-based compounds) that may be used in electrochemical cells including batteries.

### BACKGROUND OF INVENTION

Small particles may be characterized by having particle sizes on the order of microns or nanometers, and may be useful in various applications. For example, small particles including lithium-based compounds, such as lithium metal phosphates (e.g., LiFePO₄) and lithium metal oxides (e.g., LiMnNiO₂), are materials that may be used in electrochemical cells such as batteries. The materials may be processed, for example, by causing precursors to react.

Milling processes typically use grinding media to crush, or beat, a product material to smaller dimensions. For example, the product material may be provided in the form of a powder having relatively large particles and the milling process may be used to reduce the size of the particles.

Grinding media may have a variety of sizes and shapes. In a typical milling process, the grinding media are used in a device known as a mill (e.g., ball mill, rod mill, attritor mill, stirred media mill, pebble mill). Mills typically operate by distributing product material around the grinding media and rotating to cause collisions between grinding media that fracture product material particles into smaller dimensions to produce a milled product.

### SUMMARY OF INVENTION

The invention provides small particle compositions, precursors used to produce the same, and methods associated with the same.

In some embodiments, a composition comprising reaction product particles is provided, wherein at least 50% of the reaction product particles have a composition that is substantially uniform throughout an individual reaction product particle.

In some embodiments, a composition comprising reaction product particles is provided, wherein at least 50% of the reaction product particles are substantially free of precursor material.

In some embodiments, an electrode composition is provided. The composition comprises reaction product particles comprising an electrode material. The average particle size of the reaction product particles is 500 nm or less and at least 50% of the reaction product particles have a composition that is substantially uniform throughout an individual reaction product particle.

In some embodiments, an electrode composition is provided. The composition comprises reaction product particles comprising an electrode material. The average particle size of the reaction product particles is 500 nm or less and at least 50% of the reaction product particles are substantially free of precursor material.

In some embodiments, an electrode composition is provided. The composition comprises reaction product particles comprising an electrode material. The average particle size of the reaction product particles is 500 nm or less at least 50% of the reaction product particles have the same chemical composition.

In some embodiments, a composition comprising precursor particles is provided. In some embodiments, the precursor particles may have an average particle size of less than 150 nanometers and having a D₉₀ value of 250 nm or less.

Some embodiments provide methods for producing reaction product particles. In some embodiments, the method may comprise reaction of a mixture comprising precursor particles to form reaction product particles, wherein at least 50% of the reaction product particles have a composition that is substantially uniform throughout an individual reaction product particle. In some embodiments, the method may comprise reaction of a mixture comprising precursor particles to form reaction product particles, wherein at least 50% of the reaction product particles are substantially free of precursor material.

In some embodiments, a method is provided. The method comprises providing a first precursor and providing a second precursor. The method further comprises reacting the first precursor and the second precursor to form reaction product particles comprising an electrode material. The average particle size of the reaction product particles is 500 nm or less and at least 50% of the reaction product particles have a composition that is substantially uniform throughout an individual reaction product particle.

In some embodiments, a method is provided. The method comprises providing a first precursor and providing a second precursor. The method further comprises reacting the first precursor and the second precursor to form reaction product particles comprising an electrode material. The average particle size of the reaction product particles is 500 nm or less and at least 50% of the reaction product particles are substantially free of precursor material.

In some embodiments, a method is provided. The method comprises providing a first precursor and providing a second precursor. The method further comprises reacting the first precursor and the second precursor to form reaction product particles comprising an electrode material. The average particle size of the reaction product particles is 500 nm or less and at least 50% of the reaction product particles have the same chemical composition.

Other aspects, embodiments and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF THE DRAWINGS

FIGS. 1A and 1B show respective SEM images of a conventional FePO₄ reaction product particle as described in Example 1.

FIG. 1C shows particle size distribution data of a conventional FePO₄ reaction product particle as described in Example 1.

FIG. 1D shows an X-ray diffraction pattern of the conventional FePO₄ reaction product particle as described in Example 1.

FIGS. 2A and 2B show respective SEM images of a FePO₄ reaction product particle in accordance with an embodiment of the invention as described in Example 2.

FIG. 2C shows particle size distribution data of a FePO₄ reaction product particle in accordance with an embodiment of the invention as described in Example 2.

FIG. 2D shows an X-ray diffraction pattern of a FePO₄ reaction product particle in accordance with an embodiment of the invention as described in Example 2.

FIG. 3 shows charge-discharge curves for a LiFePO₄ reaction product particle in accordance with an embodiment of the invention as described in Example 3.

FIGS. 4A-E show SEM images of a 0.2Li₂MnO₃.0.8LiNi_{0.8}Co_{0.2}O₂ reaction product particle in accordance with an embodiment of the invention as described in Example 4.

FIG. 5 shows an X-ray diffraction pattern of a 0.2Li₂MnO₃.0.8LiNi_{0.8}Co_{0.2}O₂ reaction product particle in accordance with an embodiment of the invention as described in Example 4.

FIG. 6 shows a flow chart of various steps in a method for producing reaction product particles, according to one embodiment of the invention.

FIG. 7 shows reaction particle products having various levels of uniformity.

FIG. 8A shows SEM images of 0.3Li₂MnO₃.0.7LiMn_{0.5}Ni_{0.5}O₂ particles as described in Example 5.

FIG. 8B shows (i) an SEM image of 0.3Li₂MnO₃.0.7LiMn_{0.5}Ni_{0.5}O₂ particles as described in Example 5; (ii) mapping data for the particles as in (i); (iii) mapping data for Mn atoms of the particles as in (i); (iv) mapping data for Ni atoms of the particles as in (i); and (v) mapping data for O atoms of the particles as in (i).

FIG. 8C shows the EDX spectra for 0.3Li₂MnO₃.0.7LiMn_{0.5}Ni_{0.5}O₂ particles as described in Example 5.

FIG. 9A shows SEM images of 0.1Li₂MnO₃.0.9LiMn_{0.256}Ni_{0.372}Co_{0.372}O₂ particles as described in Example 5.

FIG. 9B shows (i) an SEM image of 0.1Li₂MnO₃.0.9LiMn_{0.256}Ni_{0.372}Co_{0.372}O₂ particles as described in Example 5; (ii) mapping data for the particles as in (i); (iii) mapping data for Mn atoms of the particles as in (i); (iv) mapping data for Ni atoms of the particles as in (i); (v) mapping data for Co atoms of the particles as in (i); and (vi) mapping data for O atoms of the particles as in (i).

FIG. 9C shows the EDX spectra for 0.1Li₂MnO₃.0.9LiMn_{0.256}Ni_{0.372}Co_{0.372}O₂ particles as described in Example 5.

FIGS. 10A-10D are SEM micrographs of Samples A-D respectively as described in Example 6.

FIGS. 11A-11D are SEM micrographs of iron phosphate reaction product particles produced from Samples A-D respectively as described in Example 6.

FIGS. 12A-12D respectively show the CV curves for Samples A-D as described in Example 6.

FIG. 13 compares the cycling ability of the samples as described in Example 6.

FIG. 14 shows the specific capacity measurements at different energies as described in Example 7.

FIGS. 15A-15D are copies of micrographs showing the Sample D particles as described in Example 8.

FIGS. 16A-16D are copies of micrographs showing the Sample E particles as described in Example 8.

FIGS. 17 and 18 are respective DSC curves from micron-sized precursor particles and nano-sized precursor particles as described in Example 9.

### DETAILED DESCRIPTION

Small particle compositions, precursors used to produce such compositions, as well as related methods, are described. The processes generally involve providing precursors (e.g., precursor particles) and causing them to react to form the desired reaction product particle (e.g., lithium-based compound reaction product particle). As used herein, a “reaction product particle” is a particle that includes the product of a reaction (e.g., solid state reaction, hydrothermal reaction, etc.) between precursors (e.g., precursor particles). In some embodiments, at least one of the precursors may be in the form of milled particles (e.g., FePO₄). In some cases, at least one of the precursors may be particles that are dissolved completely, or partially, in a fluid. The reaction product particles and/or precursor particles may have a very small average particle size and a unimodal particle size distribution. In some embodiments, it may be preferable for the reaction product particles and/or precursor particles to have a substantially equiaxed morphology, or a platelet morphology. In some embodiments, the reaction product particles may comprise a layered structure (e.g., layered metal oxide structure) or a layered-layered structure. As described further below, in some embodiments, milling processes involving grinding media may be used to form milled precursor particles having desired characteristics (e.g., small particle size and/or morphology). The reaction product particles may be used in a variety of different applications including energy storage, energy conversion, and/or other electrochemical applications. In some embodiments, the reaction product particles are particularly suitable for use in electrodes for batteries.

The very small size and/or morphology of the precursor particles can lead to a more complete reaction as well as a more homogeneous (e.g., uniform chemical and structural composition) reaction product particle. In some cases, precursor particles may have enhanced activity (e.g., surface activity). For example, the small size of the precursor particles may facilitate movement of lithium ions within the precursor particles, as well as between the precursor particles, during the solid state reaction, resulting in a more complete reaction. The small size of the precursor particles may also enable the reaction to proceed at a lower temperature and within a shorter reaction time, resulting in a relatively faster production throughput.

The methods may also substantially improve the electrochemical properties of the reaction product particles, including increased capacity, improved thermal stability, and extended charge/discharge cycling lifetimes. In some embodiments, the reaction product particles may reduce the amount of irreversible specific charge within a battery. For example, the reaction product particle may include lithium-based compound particles, wherein the smaller size of the particles may enhance lithium ion insertion and/or extraction during charge/discharge cycling, and may improve safety. Processes described herein are repeatable, scaleable, and may improve the consistency, manufacturability, and cost of battery materials incorporating the lithium-based compounds. A broad range of reaction product particles may be processed using the methods described herein.

In some embodiments, the reaction product particles are formed of an electrode material. That is, the reaction product particles are formed of a material that is suitable for forming an electrode. The electrode may be used, for example, in energy storage applications and/or electrochemical applications such as batteries or fuel cells. In some embodiments, it is preferable to use the reaction product as an electrode material in battery applications.

Suitable electrode materials are known in the art. In some embodiments, the reaction product particles include a lithium-based compounds. In some embodiments, the reaction product particles include other compounds or materials, such as metals, semiconductors (e.g., Si-based semiconductors), intermetallic compounds (e.g., Sn-based intermetallics, Si-based intermetallics), phosphates, composite materials, and the like. As used herein, a “lithium-based compound” is a compound that comprises lithium and one or more additional elements. Examples of suitable lithium-based compounds include lithium phosphate-based compounds (i.e., compounds that comprise lithium and a phosphate group (PO₄) and may comprise one or more additional elements); lithium oxide-based compounds (i.e., compounds that comprise lithium and oxygen and may comprise one or more additional elements); and, lithium titanate-based compounds (i.e., compounds that comprise lithium and titanium and may comprise one or more additional elements). For example, suitable lithium phosphate-based compositions may have the general formula LiMPO₄, where M may represent one or more metals including transition metals such as Fe, Mn, Co, Ni, V, Cr, Ti, Mo and Cu. Examples of suitable lithium phosphate-based compositions include LiFePO₄, LiMnPO₄ and LiFeMnPO₄. Suitable lithium oxide-based compositions may have the general formula LiₓMO_{y}, where x and y are a suitable subscripts (e.g., 1, 2, 3) and M may represent one or more metals including transition metals such as Fe, Mn, Co, Ni, V, Cr, Ti, Mo and Cu. Examples of suitable lithium oxide-based compositions include lithium cobalt oxide, lithium manganese oxide, lithium nickel manganese oxide, lithium nickel manganese cobalt oxide, or lithium nickel cobalt aluminum oxide. Suitable lithium titanate-based compositions include Li₄Ti₅O₁₂, amongst others. Lithium nickel manganese cobalt oxide or lithium nickel cobalt aluminum oxide may also be suitable.

As noted above, individual reaction product particles described herein may have a substantially uniform chemical composition. That is, the composition is substantially the same, or the same, throughout the volume of an individual particle (e.g., primary particle). For example, at least 50% of the individual reaction product particles may have a composition that is substantially uniform throughout an individual reaction product particle. In some cases, at least 10%, at least 25%, at least 40%, at least 60%, at least 70%, at least 80%, at least 90%, or greater, of the individual particles in the composition may have a substantially uniform composition throughout an individual particle.

To further illustrate, FIG. 7 shows reaction particle products having various compositions, wherein the white portions represent a first component (e.g., element, compound) of the particle and the gray portions represent a second component of the particle. FIG. 7E shows a particle having a chemical composition that is substantially uniform throughout the volume of the particle, while the particles shown in FIGS. 7A-D have chemical composition variation within each particle (e.g., some areas within the same particle rich in white portions while other areas are rich in gray portions). While the particles in FIGS. 7A-D may include regions of material that are uniform, the particles do not have a composition that is substantially uniform throughout the volume of the particle. For example, the particle in FIG. 7A comprises an inner, gray portion that is uniform throughout the inner, gray portion, and an outer, white portion that is uniform throughout the outer, white portion. However, the particle in FIG. 7A does not have a composition that is substantially uniform throughout the volume of the particle.

In some cases, individual reaction product particles may be substantially uniform in that they are substantially free of undesired material (e.g., precursor particles, undesired byproducts) or substantially free of regions comprising undesired material. In some cases, at least 50% of the reaction product particles are substantially free of precursor material. In some cases, at least 60%, at least 70%, at least 80%, at least 90%, or greater, of the individual reaction product particles are substantially free of precursor material. As used herein, a composition “substantially free of precursor material” means a composition including less than 2% precursor material. In some cases, the reaction product particles have a composition having less than 1%, or essentially 0%, precursor material.

In some cases, a majority (e.g., at least 50%) of the individual reaction product particles may have a composition that is substantially free of byproducts. A byproduct refers to an undesired species that may be formed during a reaction between precursor particles to produce reaction product particles. Typically, the undesired byproduct material is a species that adversely affects certain properties of the reaction product particle. It should be understood, however, that some embodiments of the invention provide reaction product particles comprising additional materials (e.g., co-products) that improve and/or enhance properties of the reaction product particles, as described more fully below.

In an illustrative embodiment, a composition may include lithium iron phosphate reaction product particles produced via a reaction between a lithium-containing compound (e.g., lithium hydroxide, lithium carbonate) and iron phosphate. In the resulting composition, a majority (e.g., 50% or greater) of the lithium iron phosphate reaction product particles may have a composition that is substantially uniform throughout an individual reaction product particle, i.e., the individual particles are substantially free of regions rich in iron phosphate, regions rich in lithium, and/or regions rich other byproducts or precursor materials.

This composition uniformity on the particle level provides advantages over certain conventional reaction product particles (e.g., lithium-based compound reaction product particles), which have particles with heterogeneous composition due to, in some cases, incomplete and/or non-uniform reaction of precursor particles. For example, conventional lithium-based compound reaction product particles may include some regions rich in undesired byproducts and/or precursor particles, such as FePO₄. The presence of regions rich in undesired byproducts or precursor particles may, in some embodiments, adversely affect certain properties of the particles. In some cases, methods described herein may provide the ability to perform faster and more complete solid state reactions, wherein an increased amount of precursor particles are converted to the reaction product particle and formation of undesired byproducts is reduced, resulting in formation of a substantially uniform reaction product particle.

The uniformity of the composition of the reaction product particles may be observed using various techniques. In some cases, the presence and/or amount of region within the reaction product particles may be observed using X-ray diffraction (XRD) techniques. For example, the presence of heterogeneous regions within a bulk sample of reaction product particles may be indicated by the presence of an XRD peak. In some cases, compositional mapping techniques (e.g., EDS) may be used, where a voltage is applied to the reaction product particles to produce an image showing the location of specific atoms within the reaction product particles. The amount and/or distribution of the different types of atoms (e.g., metal atoms) over a sample may indicate the level of uniformity of the composition. For example, the homogeneous distribution of different types of metal atoms (e.g., Li, Fe, Mn, Co, Ni, etc) throughout the reaction product particles may indicate a substantially uniform reaction product particle, while the presence of relatively large, heterogeneous regions rich in one type of metal atom may indicate a reaction product particle that is not substantially uniform. The extent of uniformity may also be assessed using DSC (Differential Scanning Calorimetry) to analyze the reaction characteristics of the precursors.

In some embodiments, a majority of reaction product particles may also have substantially the same chemical composition. In some cases, at least 10%, at least 25%, at least 40%, at least 50%, at least 60%, at least 70%, at least 80%, at least 90%, or greater, of individual reaction product particles have substantially the same chemical composition. For example, in some cases, a substantial majority of the individual reaction product particles may include the product of a reaction, such as a solid-state reaction.

Some embodiments of the invention may also provide reaction product particles including various regions comprising a desired co-product. In some cases, the co-product may be formed during the reaction between precursor materials, in addition to a reaction product. In some embodiments, the co-product may be a conductive material. In some embodiments, the co-product may be an insulating material. In some embodiments, the co-product may be a magnetic material. In some cases, the co-product may provide stability (e.g., structural stability, electrochemical stability, etc.) to the reaction product particles. Using methods of the invention, the type and/or amount of co-products formed within the reaction product particles may be selected to suit a particular application. In an illustrative embodiment, lithium iron phosphate particles may be formed, wherein the particles include a iron(II) phosphate co-product.

In some embodiments, the lithium-based compound reaction product particle includes particles having a layered structure. Layered structures may, in some cases, provide sufficient structural stability within a material (e.g., particle, agglomerate of particles) to allow for the transport of various species, including charged species, through the structure. For example, the layered structure may include a structurally stable “host” material (e.g., a metal oxide) and a “guest” material (e.g., Li ions) that can be transported through the host material. Such structures may be useful, for example, in batteries, where lithium ions are inserted into and extracted from a material (e.g., electrode) during charge/discharge cycles. In an illustrative embodiment, a layered structure may include one or more lithium-based compound particles, such as LiMO₂, where M represents one or more metals, as noted above. In some cases, M is Mn, Ni, Co, Al, Ti, or combinations thereof. Examples of lithium-based compound particles having a layered structure include LiCoO₂, LiNi_{0.8}Co_{0.2}O₂, and LiNi_{0.8}Co_{0.15}Al_{0.05}O₂, In some embodiments, the reaction particle products have a layered-layered structure, which may include at least two different types of structurally stable “host” materials (e.g., metal oxides) and a “guest” material (e.g., Li ions) that can be transported through the host materials. For example, a layered-layered structure may include one or more lithium-based compound particles, such as Li(M¹ᵥM²ₓM³_{y}M⁴_{z}Li_{(1-v-x-y-z)})O₂, where each of M¹⁻⁴ represents one or more metals, as noted above, and x, y, and z are greater than zero. In some embodiments, the layered-layered structure includes two types of lithium-based compound particles, such as Li₂MnO₃ and LiMO₂, wherein the M represents one or metals, as described above. In some cases, the different types of lithium-based compound particles may be present in various ratios, such that the layered-layered structure has the formula, xLi₂MO₃.(1−x)LiMO₂, wherein x is greater than zero. Examples of lithium-based compound particles having a layered-layered structure include 0.3Li₂MnO₃.0.7LiMn_{0.5}Ni_{0.5}O₂, 0.1Li₂MnO₃.0.9LiMn_{0.256}Ni_{0.372}Co_{0.372}O₂, and 0.2Li₂MnO₃.0.8LiNi_{0.8}Co_{0.2}O₂.

It should be understood that the reaction product particles may also include suitable dopants which may enhance certain properties of the reaction product particles, including electrical conductivity. Examples of dopants include titanium, aluminum, etc.

Suitable lithium-based compound compositions have been described in U.S. Pat. Nos. 5,871,866; 6,136,472; 6,153,333; 6,203,946; 6,387,569; 6,387,569; 6,447,951; 6,528,033; 6,645,452; 6,667,599; 6,702,961; 6,716,372; 6,720,110; and, 6,724,173 which are incorporated herein by reference.

In some embodiments, the reaction product particles have an average particle size of 500 nm or less. In certain embodiments, the average particle size may be even smaller. For example, the average particle size may be less than 250 nm, less than 150 nm, less than 100 nm, less than 75 nm, or less than 50 nm. In some embodiments, it may be preferred for the reaction product particles to have very small particle sizes (e.g., an average particle size of less than 100 nm). In some cases, it is even possible to produce reaction product particles having an average particle size of less than 30 nm, less than 20 nm, or less than 10 nm. Such particle sizes may be obtained, in part, by using grinding media having certain preferred characteristics, as described further below.

It should be understood that not all of the reaction product particles are within the above-noted ranges.

The preferred average particle size of the reaction product particles typically depends on the intended application. In certain applications, it may be desired for the average particle size to be extremely small (e.g., less than 100 nm); while, in other applications, it may be desired for the average particle size to be slightly larger (e.g., between 100 nm and 500 nm). In some cases, the reaction product particles are not milled. However, in other cases, it may be desirable to mill the reaction product particles. In general, milling parameters may be controlled to provide a desired particle size, though in certain cases it may be preferable for the average particle size to be greater than 1 nm to facilitate milling. For example, the average particle size of a milled material may be controlled by a number of factors including grinding media characteristics (e.g., density, size, hardness, toughness), as well as milling conditions (e.g., specific energy input).

It should be understood that the average particle size of a reaction product particle is the average primary particle size of the reaction product and may be determined by measuring an average cross-sectional dimension (e.g., diameter for substantially spherical particles) of a representative number of primary particles. For example, the average cross-sectional dimension of a substantially spherical particle is its diameter; and, the average cross-sectional dimension of a non-spherical particle is the average of its three cross-sectional dimensions (e.g., length, width, thickness), as described further below. The particle size may be measured using a laser particle measurement instrument, a scanning electron microscope or other conventional techniques.

Some embodiments may include reaction product particles having uniform particle size distribution, i.e., a narrow particle size distribution. For example, the reaction product particles may also be relatively free of large particles. That is, the reaction product particles may include only a small concentration of larger particles. In some embodiments, the reaction product particle may exhibit a unimodal particle distribution. In some cases, the D₉₀ values for the compositions may be any of the above-described average particle sizes. Though, it should be understood that the invention is not limited to such D₉₀ values. In some embodiments, the reaction product particles may have uniform particle distribution and may exhibit high packing density and/or enhanced electrochemical properties.

The reaction product particles may also have a very high average surface area. The high surface area is, in part, due to the very small particle sizes noted above. The average surface area of the reaction product particles may be greater than 1 m²/g; in other cases, greater than 5 m²/g; and, in other cases, greater than 50 m²/g. In some cases, the particles may have extremely high average surface areas of greater than 100 m²/g; or, even greater than 500 m²/g. It should be understood that these high average surface areas are even achievable in particles that are substantially non-porous, though other particles may have surface pores. Such high surface areas may be obtained, in part, by using grinding media having certain preferred characteristics, as described further below.

Similar to particle size, the preferred average surface area of the reaction product particle typically depends on the intended application. In certain applications, it may be desired for the average surface area to be extremely large (e.g., greater than 50 m²/g); while, in other applications, it may be desired for the average surface area to be slightly smaller (e.g., between 50 m²/g and 1 m²/g). In general, milling parameters may be controlled to provide a desired surface area, though in certain cases it may be preferable for the average surface area to be less than 3,000 m²/g (e.g., for substantially non-porous particles). For example, the average surface area of the reaction product particles may be controlled by a number of factors including grinding media characteristics (e.g., density, size, hardness, toughness), as well as milling conditions (e.g., energy, time).

Amongst other advantages, the small particle size and/or high surface areas may lead to improved electrochemical performance (e.g., for batteries) such as increased charging/discharging rates, increased power density and increased operational lifetime (e.g., the number of charging/discharging cycles without degeneration).

In some embodiments, the reaction product may be in the form of an agglomerate of particles. As used herein, agglomerates of particles are referred to as “agglomerates”. The agglomerate may comprise a plurality of particles (e.g., lithium-based compound particles) as described herein, and may have an average agglomerate size that is 50 microns or less, 25 microns or less, or 10 microns or less. In some embodiments, the agglomerate of particles may have an average agglomerate size that is in the range of 1-25 microns, 1-10 microns, or, 2-8 microns. It should be understood that the average agglomerate size may be determined by measuring an average cross-sectional dimension (e.g., diameter for substantially spherical agglomerates) of a representative number of agglomerates. The agglomerate size may be measured using a scanning electron microscope or other conventional techniques.

As described herein, the reaction product particles can be produced in a milling process. Thus, these reaction product particles may be described as having a characteristic “milled” morphology/topology. Those of ordinary skill in the art can identify “milled particles,” which, for example, can include one or more of the following microscopic features: multiple sharp edges, faceted surfaces, and being free of smooth rounded “corners” such as those typically observed in chemically-precipitated particles. It should be understood that the milled particles described herein may have one or more of the above-described microscopic features, while having other shapes (e.g., platelet) when viewed at lower magnifications. In some cases, the reaction product particles may have a spherical or equiaxed morphology.

In some cases, reaction product particles having a particular morphology or topology may be produced using processes other than milling, as described more fully below.

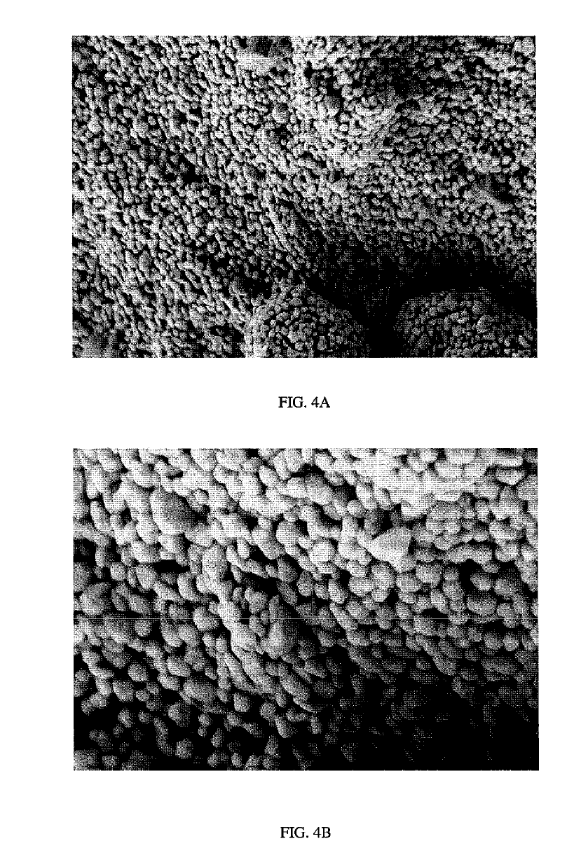

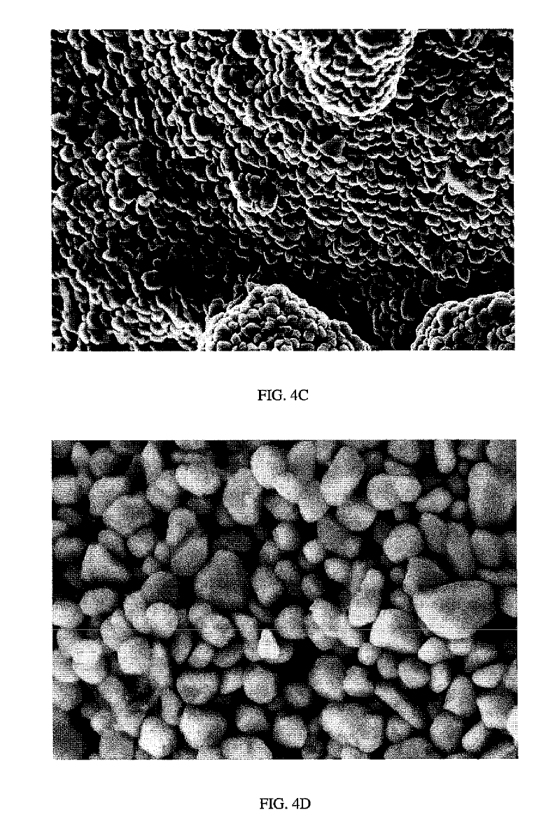

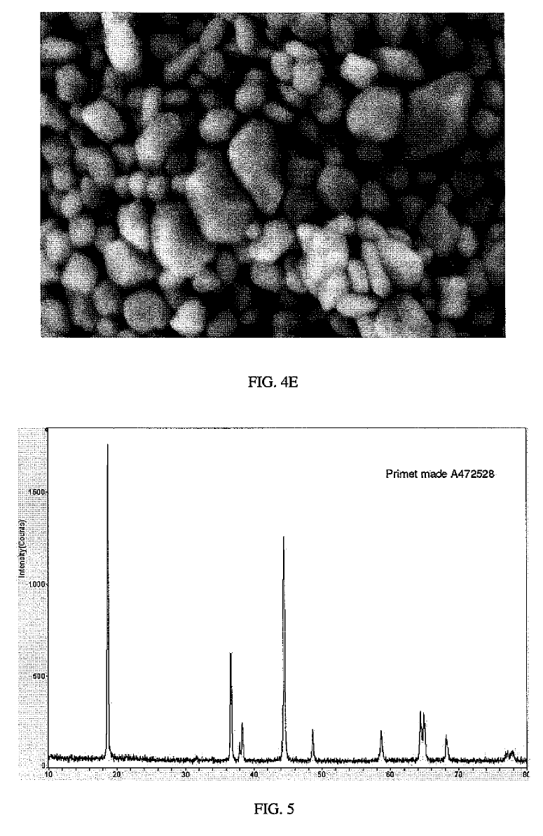

In some embodiments, it may be preferable for particles of the reaction product particles to have a substantially equiaxed shape. For example, the lithium-based compound reaction product particles shown in FIGS. 4A-4G have a substantially equiaxed shape. Other shapes may also be preferable including platelet shapes. In these cases, the particles may have a relatively uniform thickness across the length of the particle. The particles may have a substantially planar first surface and a substantially planar second surface with the thickness extending therebetween. The particle thickness may be smaller than the particle width and particle length. In some embodiments, the length and width may be approximately equal; however, in other embodiments the length and width may be different. In cases where the length and width are different, the platelet particles may have a rectangular box shape. In certain cases, the particles may be characterized as having sharp edges. For example, the angle between a top surface (e.g., first planar surface) of the particle and a side surface of the particle may be between 75° and 105°; or between 85° and 95° degrees (e.g., about 90°).

In some embodiments, the reaction product particles may have a substantially spherical or oblate spheroid shape, a substantially equiaxed shape, a substantially platelet shape, a substantially rod-like shape, amongst others. It should be understood that within a reaction product particle, individual particles may be in the form of one or more of the above-described shapes.

In some embodiments, the compositions of the invention may comprise reaction product particles having a preferred crystallographic orientation. Suitable methods of forming the such particles have been described in commonly-owned, co-pending U.S. Patent Publication No. US2007/0098803A1, entitled “Small Particle products and Associated Methods,” published on May 3, 2007, which is incorporated herein by reference. In some embodiments, a majority (i.e., greater than 50%) of the particles in a composition may have the same crystallographic orientation. In other embodiments, greater than 75% of the particles, or even greater than 95%, or even substantially all, of the particles in a composition may have the same crystallographic orientation.

The preferred crystallographic orientation of the reaction product particles may depend, in part, on the crystal structure (e.g., hexagonal, tetragonal) of the material that forms the particles. Crystals generally preferentially fracture along specific planes with characteristic amounts of energy being required to induce fracture along such planes. During milling, such energy results from particle/grinding media collisions. It is observed that, by controlling the energy of such collisions via milling parameters (e.g., grinding media composition, specific energy input), it is possible to preferentially fracture particles along certain crystallographic planes which creates a reaction product particle having a preferred crystallographic orientation.

In some embodiments, the preferred crystallographic orientation is defined by a basal plane (i.e., the plane which is perpendicular to the principal axis (c axis) in a tetragonal or hexagonal structure). For example, the basal plane, and crystallographic orientation, may be the (0001) or (001) plane.

Crystallographic orientation of particles may be measured using known techniques. A suitable technique is x-ray diffraction (XRD). It may be possible to assess the relative percentage of particles having the same preferred crystallographic orientation using XRD.

Though the above discussion relates to characteristics of reaction product particles produced using methods described herein, it should also be understood that the precursor particles described herein may also having the above-described particle sizes, surface areas, morphology, and other characteristics. For example, one or more types of precursor particles may have an average particle size of 500 nm or less. In certain embodiments, the average particle size may be even smaller. For example, the average particle size may be less than 250 nm, less than 150 nm, less than 100 nm, less than 75 nm, less than 50 nm, less than 30 nm, less than 20 nm, or less than 10 nm.

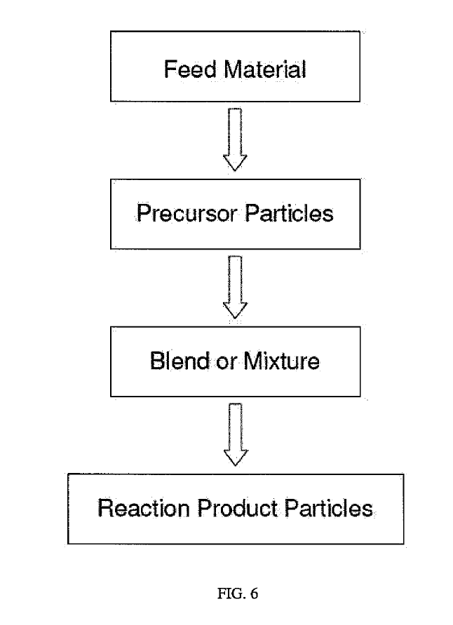

As noted above, methods for producing reaction product particles are also provided. In some cases, the methods described herein may provide a faster, more direct process for forming reaction product particles, relative to known methods. For example, some embodiments involve a solid-state reaction between precursor particles to produce the reaction product particle, rather than wet chemical techniques that can require various reaction, precipitation, and/or isolation steps. FIG. 6 shows an illustrative embodiment of various steps of a method for producing reaction product particles.

For example, the method may involve providing a feed material comprising one or more types of metal-containing materials. In some embodiments, one type of the particles precursor comprises lithium, i.e., is a lithium-containing compound (e.g., lithium carbonate, lithium hydroxide), and a second type comprises other elements (e.g. FePO₄). The feed material may optionally comprise a fluid carrier, such as water, N-methylpyrrolidinone, alcohols (e.g., isopropanol), or the like. In some embodiments, at least a portion of (e.g., at least one component of) the feed material is dissolved in a fluid carrier. For example, one of the precursors may be dissolved in a fluid carrier. The method may involve processing the feed material to produce one or more types of precursor particles. In some embodiments, the feed material may be milled. In other embodiments, the feed material is not milled.

The methods typically involve mixing the appropriate precursors to form a mixture. In some cases, the precursors may be mixed using a mill, as described more fully below. For example, a feed material including one or more types of precursor particles, such as a lithium-containing compound in combination with precursor particles that do not include lithium, may be milled to form a mixture. In some embodiments, a mill may be used to mill the precursor particles to smaller particle sizes (e.g., less that 1 micron), or to mix the precursor particles without substantially further reducing particle size. In some embodiments, the precursor particles may also be deagglomerated during milling. Milling a mixture of precursor particles may also, in some cases, cause a reaction (e.g., a solid-state reaction) between at least a portion of the precursor particles to form a composition including lithium-based compound particles.

In some embodiments, a fluid carrier may be used during milling. For example, precursor particles may be milled in the presence of a fluid carrier to at least partially dissolve the particles in the fluid carrier. In some cases, the fluid carrier may facilitate mixing of the precursor particles in the mill. For example, in some embodiments, at least a portion of the precursor particles is dissolved in a fluid carrier. Suitable fluid carriers include water, N-methylpyrrolidinone, alcohols (e.g., isopropanol), among others. When the mixture (e.g., blend) of precursor particles is milled in the presence of a fluid carrier, typically the mixture is removed from the mill and dried. In some cases, the mixture can be dried under vacuum.

In other embodiments, the mixture may not be mixed using a mill, but may be mixed using other techniques (e.g., stirring, sonication). For example, wet chemistry techniques may be employed, wherein at least a portion of the precursor particles can be dissolved in a fluid carrier, for example, at a particular temperature, concentration, or pH. The precursor particles and/or reaction product particles may then be recovered by recrystallization, for example, by changing the pH of the fluid carrier, and/or drying.

The methods may also involve causing a reaction between the precursors (e.g., precursor particles) to occur. In some cases, the mixture may be exposed to hydrothermal conditions to form the reaction product particles. In some embodiments, the precursor mixture is heated to an appropriate temperature to cause a solid state reaction between precursor particles, thus, forming the desired reaction product particle (e.g., lithium-based compound particle). For example, a mixture including one or more types of precursors can be heated at a temperature of at least 500° C. to form the lithium-based compound reaction product particle. In some cases, the precursors can be heated at a temperature of at least 600° C., at least 700° C., at least 800° C., or higher, to form the lithium-based compound reaction product particle. Other temperatures may also be used.

In an illustrative embodiment, a method may involve milling a feed material comprising FePO₄ to form milled FePO₄ precursor particles having a small particle size (e.g., less than 1 micron). A second type of precursor particle, for example, Li₂CO₃ or LiOH, may be added to the milled FePO₄ precursor particles, optionally with a fluid carrier. The components may then be milled to form a mixture, a portion of which may include lithium-based compound particles. The mixture may be further processed (e.g., dried) to remove any fluid carriers, if present. The mixture may then be heated to cause a solid state reaction between precursor particles to form the lithium-based compound reaction product particle.

The reaction product particle may be further processed as desired for the intended application. For example, known processing techniques may be used to incorporate the particles in components (e.g., electrodes) used in electrochemical cells (e.g., batteries) as described above. The electrochemical cells (e.g., batteries) may be used in applications requiring small dimensions such as smart cards. In some embodiments, the particles may be coated with a thin layer of material (e.g., carbon). It should be understood that the reaction product particles may be used in any other suitable application and that the invention is not limited in this regard. Suitable coatings and related processes have been described in U.S. Patent Application Serial US-2008-0280141 which is based on U.S. patent application Ser. No. 11/712,831, filed Feb. 28, 2007, and is incorporated herein by reference.

An advantage of some embodiments of the invention is the ability to control the morphology of materials at various stages during the fabrication process. For example, the precursor particles, mixture comprising precursor particles, and/or reaction product particles may be selected to have a particular morphology at any stage during the fabrication process. In some cases, a particular morphology may be obtained based on the selection of metal-containing materials and/or precursor particles, or combinations thereof. In some cases, the reaction conditions (e.g., reaction temperature, reaction time, selection of fluid carriers, etc.) may affect the morphology of the resulting material. In some cases, use of a lithium hydroxide precursor, for example, may lead to formation of reaction product particles having a platelet morphology. In some cases, use of a lithium carbonate precursor, for example, may lead to formation of reaction product particles having an equiaxed morphology.

Some embodiments of the invention may involve materials (e.g., precursor particles, mixture comprising precursor particles, and/or reaction product particles) having the same morphology throughout various steps of the fabrication process. Some embodiments of the invention may involve materials having different morphologies throughout various stages of the fabrication process, wherein the morphology of the material may be controlled at each stage, as described above.

Another advantage of certain embodiments of the invention is that the particle sizes described herein can be achieved at very low contamination levels. The grinding media noted below may enable the low contamination levels when used with the above-described compositions because such characteristics lead to very low wear rates. For example, the milled compositions may have contamination levels may be less than 900 ppm, less than 500 ppm, less than 200 ppm, or even less than 100 ppm. In some processes, virtually no contamination may be detected which is generally representative of contamination levels of less than 10 ppm. As used herein, a “contaminant” is grinding media material introduced into the product material composition during milling. It should be understood that typical commercially available feed product materials may include a certain impurity concentration (prior to milling) and that such impurities are not includes in the definition of contaminant as used herein. Also, other sources of impurities introduced in to the product material, such as material from the milling equipment, are not included in the definition of contaminant as used herein. The “contamination level” refers to the weight concentration of the contaminant relative to the weight concentration of the milled material. Typical units for the contamination level are ppm. Standard techniques for measuring contamination levels are known to those of skill in the art including chemical composition analysis techniques.

The precursors react to form the reaction product particles. For example, the precursors particles described herein are particles that react to form the reaction product particles (e.g., lithium-based compound reaction product particles). In some cases, the precursor particles may be lithium-based compound precursor particles (even if the precursor particles do not comprise lithium). In some embodiments, one type of the particles precursor comprises lithium, i.e., is a lithium-containing compound (e.g., lithium carbonate, lithium hydroxide), and a second type comprises other elements (e.g. FePO₄). It should be understood that more than two types of precursor particles may be used. One, two, or all of the precursors may be milled as described above and further below.

Any suitable type of precursor may be used. In some embodiments, lithium-based compound precursor may be used. Suitable types of lithium-based compound precursor particles include lithium phosphate-based compounds, lithium oxide-based compound and lithium titanate-based compounds. Suitable types also include aluminum nitrate, ammonium dihydrogen orthophosphate, ammonium monohydrogen orthophosphate, cobalt hydroxide, cobalt nitrate, cobalt oxide, iron acetate, iron oxide, iron phosphate, manganese acetate, manganese carbonate, manganese hydroxide, manganese oxide, nickel hydroxide, nickel nitrate, nickel oxide, or titanium oxide. Suitable types also include lithium carbonate, lithium acetate, lithium dihydrogen phosphate, lithium hydroxide, lithium nitrate, or lithium iodide.

The amount and type of precursor particles may be selected, in combination, to produce a reaction product particle having a particular chemical composition, structure, and/or morphology upon solid-state reaction. For example, as noted above, methods described herein may involve the selection of one or more precursor particles to produce a reaction product particle having a desired morphology. In some cases, lithium hydroxide may be used as a precursor particle to produce particles with, for example, an equiaxed primary particle morphology. In some cases, lithium carbonate may be used as a precursor particle to produce particles with a block-like particle morphology. The precursor particles may also be selected to produce reaction product particles, using methods described herein, having uniform particle size distribution. In some cases, the precursors may also be selected to produce reaction product particles having a rounded morphology. In some embodiments, the precursors can be selected to produce reaction product particles having high packing density.

The precursor particles may also be selected to have small particle size (e.g., less than 100 nm). In some cases, the use of small size particles allow a more complete solid state reaction as well as a more homogeneous (uniform chemical and structural composition) product. The small size of the particles enables the solid state reaction to proceed at a lower temperature and a shorter soak time (faster production throughput). This in turn will improve electrochemical properties. As noted above, the small size of particles can enhance lithium ion insertion and extraction during a charge/discharge cycle of a battery.

In some cases, the precursors may be milled. In some cases, the precursors may be milled together. In other embodiments, the precursors are not milled. In some embodiments, the reaction product particles are milled.

As noted above, it may be preferred to use grinding media having specific characteristics. However, it should be understood that not every embodiment of the invention is limited in this regard. In some embodiments, the grinding media is formed of a material having a density of greater than 6 grams/cm³; in some embodiments, greater than 8 grams/cm³; in some embodiments, the density is greater than 10 grams/cm³; or greater than 15 grams/cm³; or, even, greater than 18 grams/cm³. Though, in certain embodiments, the density of the grinding media may be less than 22 grams/cm³, in part, due to difficulties in producing suitable grinding materials having greater densities. It should be understood that conventional techniques may be used to measure grinding media material density.

In certain embodiments, it also may be preferable for the grinding media to be formed of a material having a high fracture toughness. For example, in some cases, the grinding media is formed of a material having a fracture toughness of greater than 6 MPa/m^{1/2}; and in some cases, the fracture toughness is greater than 9 MPa/m^{1/2}. The fracture toughness may be greater than 12 MPa/m^{1/2} in certain embodiments. Conventional techniques may be used to measure fracture toughness. Suitable techniques may depend, in part, on the type of material being tested and are known to those of ordinary skill in the art. For example, an indentation fracture toughness test may be used. Also, a Palmqvist fracture toughness technique may be suitable, for example, when testing hard metals.

It should be understood that the fracture toughness values disclosed herein refer to fracture toughness values measured on bulk samples of the material. In some cases, for example, when the grinding media are in the form of very small particles (e.g., less than 150 micron), it may be difficult to measure fracture toughness and the actual fracture toughness may be different than that measured on the bulk samples.

In certain embodiments, it also may be preferable for the grinding media to be formed of a material having a high hardness. It has been found that media having a high hardness can lead to increased energy transfer per collision with product material which, in turn, can increase milling efficiency. In some embodiments, the grinding media is formed a material having a hardness of greater than 75 kgf/mm²; and, in some cases, the hardness is greater than 200 kgf/mm². The hardness may even be greater than 900 kgf/mm² in certain embodiments. Conventional techniques may be used to measure hardness. Suitable techniques depend, in part, on the type of material being tested and are known to those of ordinary skill in the art. For example, suitable techniques may include Rockwell hardness tests or Vickers hardness tests (following ASTM 1327). It should be understood that the hardness values disclosed herein refer to hardness values measured on bulk samples of the material. In some cases, for example, when the grinding media are in the form of very small particles (e.g., less than 150 micron), it may be difficult to measure hardness and the actual hardness may be greater than that measured on the bulk samples.

It should be understood that not all milling processes of the present invention use grinding media having each of the above-described characteristics.

Milling processes of the invention may use grinding media having a wide range of dimensions. In general, the average size of the grinding media is between about 0.5 micron and 10 cm. The preferred size of the grinding media used depends of a number of factors including the size of the feed particles, desired size of the reaction product particle, grinding media composition, and grinding media density, amongst others.

In certain embodiments, it may be advantageous to use grinding media that are very small. It may be preferred to use grinding media having an average size of less than about 250 microns; or, less than about 150 microns (e.g., between about 75 and 125 microns). In some cases, the grinding media may have an average size of less than about 100 microns; or even less than about 10 microns. Grinding media having a small size have been shown to be particularly effective in producing reaction product particles having very small particle sizes (e.g., less than 1 micron). In some cases, the grinding media may have an average size of greater than 0.5 micron.

It should be understood that the average size of grinding media used in a process may be determined by measuring the average cross-sectional dimension (e.g., diameter for substantially spherical grinding media) of a representative number of grinding media particles. The grinding media size may be measured using conventional techniques such as suitable microscopy techniques or standard sieve size screening techniques.

The grinding media may also have a variety of shapes. In general, the grinding media may have any suitable shape known in the art. In some embodiments, it is preferred that the grinding media be substantially spherical (which may be used herein interchangeably with “spherical”). Substantially spherical grinding media have been found to be particularly effective in obtaining desired milling performance.

It should also be understood that any of the grinding media used in methods of the invention may have any of the characteristics (e.g., properties, size, shape, composition) described herein in combination with one another. For example, grinding media used in methods of the invention may have any of the above-noted densities and above-noted average sizes (e.g., grinding media may have a density of greater than about 6 grams/cm³ and an average size of less than about 250 micron).

The above-described grinding media characteristics (e.g., density, hardness, toughness) are dictated, in part, by the composition of the grinding media. In certain embodiments, the grinding media may be formed of a metallic material including metal alloys or metal compounds. In one set of embodiments, it may be preferred that the grinding media are formed of ferro-tungsten material (i.e., Fe—W). In some cases, the compositions may comprise between 75 and 80 weight percent iron and between 20 and 25 weight percent tungsten. In some cases, ferro-tungsten grinding media may be carburized to improve wear resistance.

In other embodiments, the grinding media may be formed of a ceramic material such as a carbide material. In some embodiments, the grinding media to be formed of a single carbide material (e.g., iron carbide (Fe₃C), chromium carbide (Cr₇C₃), molybdenum carbide (Mo₂C), tungsten carbide (WC, W₂C), niobium carbide (NbC), vanadium carbide (VC), and titanium carbide (TiC)). In some cases, it may be preferred for the grinding media to be formed of a multi-carbide material. A multi-carbide material comprises at least two carbide forming elements (e.g., metal elements) and carbon.

A multi-carbide material may comprise a multi-carbide compound (i.e., a carbide compound having a specific stoichiometry; or, a blend of single carbide compounds (e.g., blend of WC and TiC); or, both a multi-carbide compound and a blend of single carbide compounds. It should be understood that multi-carbide materials may also include other components such as nitrogen, carbide-forming elements that are in elemental form (e.g., that were not converted to a carbide during processing of the multi-carbide material), amongst others including those present as impurities. Typically, but not always, these other components are present in relatively minor amounts (e.g., less than 10 atomic percent).

Suitable carbide-forming elements in multi-carbide grinding media of the invention include iron, chromium, hafnium, molybdenum, niobium, rhenium, tantalum, titanium, tungsten, vanadium, zirconium, though other elements may also be suitable. In some cases, the multi-carbide material comprises at least two of these elements. For example, in some embodiments, the multi-carbide material comprises tungsten, rhenium and carbon; in other cases, tungsten, hafnium and carbon; in other cases, molybdenum, titanium and carbon.

Suitable grinding media compositions have been described, for example, in U.S. Patent Publication No. US2006/0003013A1, published on Jan. 5, 2006, entitled “Grinding Media Compositions and Methods Associated With the Same,” which is incorporated herein by reference.

In some embodiments, it may be preferred for the multi-carbide material to comprise at least tungsten, titanium and carbon. In some of these cases, the multi-carbide material may consist essentially of tungsten, titanium and carbon, and is free of additional elements in amounts that materially affect properties. Though in other cases, the multi-carbide material may include additional metal carbide forming elements in amounts that materially affect properties. For example, in these embodiments, tungsten may be present in the multi-carbide material in amounts between 10 and 90 atomic %; and, in some embodiments, in amounts between 30 and 50 atomic %. The amount of titanium in the multi-carbide material may be between 1 and 97 atomic %; and, in some embodiments, between 2 and 50 atomic %. In these embodiments that utilize tungsten-titanium carbide multi-carbide material, the balance may be carbon. For example, carbon may be present in amounts between 10 and 40 atomic %. As noted above, it should also be understood that any other suitable carbide forming elements can also be present in the multi-carbide material in these embodiments in addition to tungsten, titanium and carbon. In some cases, one or more suitable carbide forming elements may substitute for titanium at certain sites in the multi-carbide crystal structure. Hafnium, niobium, tantalum and zirconium may be particularly preferred as elements that can substitute for titanium. Carbide-forming elements that substitute for titanium may be present, for example, in amounts of up to 30 atomic % (based on the multi-carbide material). In some cases, suitable multi-carbide elements may substitute for tungsten at certain sites in the multi-carbide crystal structure. Chromium, molybdenum, vanadium, tantalum, and niobium may be particularly preferred as elements that can substitute for tungsten. Carbide-forming elements that substitute for tungsten may be present, for example, in amounts of up to 30 atomic % (based on the multi-carbide material). It should also be understood that the substituting carbide forming elements noted above may completely substitute for titanium and/or tungsten to form a multi-carbide material free of tungsten and/or titanium.

It should be understood that grinding media compositions that are not disclosed herein but have certain above-noted characteristics (e.g., high density) may be used in embodiments of the invention. Also, it should be understood that milling processes of the present invention are not limited to the grinding media compositions and/or characteristics described herein. Other suitable grinding media may also be used.

In general, any suitable process for forming grinding media compositions may be used. In some cases, the processes involve heating the components of the composition to temperatures higher than the respective melting temperatures of the components followed by a cooling step to form the grinding media. A variety of different heating techniques may be used including a thermal plasma torch, melt atomization, and arc melting, amongst others. For example, one suitable process involves admixing fine particles of the elements intended to comprise the grinding media in appropriate ratios. The stability of the mixture may be enhanced by introduction of an inert binding agent (e.g., which burns off and does not form a component of the grinding material). The mixture may be subdivided into a plurality of aggregates (e.g., each having a mass approximately equal to that of the desired media particle to be formed). The aggregates may be heated to fuse (e.g., to 90% of theoretical density) and, eventually, melt individual aggregates to form droplets that are cooled to form the grinding media. In some embodiments, the grinding media may be formed of two different materials. For example, the grinding media may be formed of a blend of two different ceramic materials (e.g., a blend of high density ceramic particles in a ceramic matrix); or a blend of a ceramic material and a metal (e.g., a blend of high density ceramic materials in a metal matrix).

In some embodiments in which the grinding media comprises more than one material component, the grinding media may comprise coated particles. The particles may have a core material and a coating formed on the core material. The coating typically completely covers the core material, but not in all cases. The composition of the core and coating materials may be selected to provide the grinding media with desired properties such as a high density. For example, the core material may be formed of a high density material (e.g., greater than 8 grams/cm³). The core, for example, may be formed of a metal such as steel or depleted uranium; or a ceramic such as a metal carbide.

As noted above, reaction product particles may be produced in a milling process that use grinding media as described herein. The processes may utilize a wide range of conventional mills having a variety of different designs and capacities. Suitable types of mills include, but are not limited to, ball mills, rod mills, attritor mills, stirred media mills, pebble mills and vibratory mills, among others.

In some cases, conventional milling conditions (e.g., energy, time) may be used to process the reaction product particles using the grinding media described herein. In other cases, the grinding media described herein may enable use of milling conditions that are significantly less burdensome (e.g., less energy, less time) than those of typical conventional milling processes, while achieving a superior milling performance (e.g., very small average particle sizes).

One aspect of the invention is that the small reaction product particles of the invention may be produced using very low specific energy input (i.e., energy consumed in milling process per weight of feed material).

Milling processes of the invention can involve the introduction of feed material (e.g., feed particles) and a milling fluid (e.g., a fluid that does not react with the reaction product particles) into a processing space in a mill in which the grinding media are confined. The viscosity of the slurry may be controlled, for example, by adding additives to the slurry such as dispersants. The mill is rotated at a desired speed and material particles mix with the grinding media. Collisions between the particles and the grinding media can reduce the size of the particles. The particles are typically exposed to the grinding media for a certain mill time after which the milled material is separated from the grinding media using conventional techniques, such as washing and filtering, screening or gravitation separation.

In some processes, the slurry of particles is introduced through a mill inlet and, after milling, recovered from a mill outlet. The process may be repeated and, a number of mills may be used sequentially with the outlet of one mill being fluidly connected to the inlet of the subsequent mill.

As noted above, such milling processes may be used to form one or more of the types of precursor particles or reaction product particles.

It should be understood that not all embodiments of the invention are limited to milled particles or milling processes.

The following examples are s intended to be illustrative and are not limiting.

### EXAMPLES

### Example 1

This example illustrates characterization of a conventional FePO₄ reaction product particle. Such a reaction product particle can be used as a precursor when forming conventional lithium iron phosphate reaction product particles.

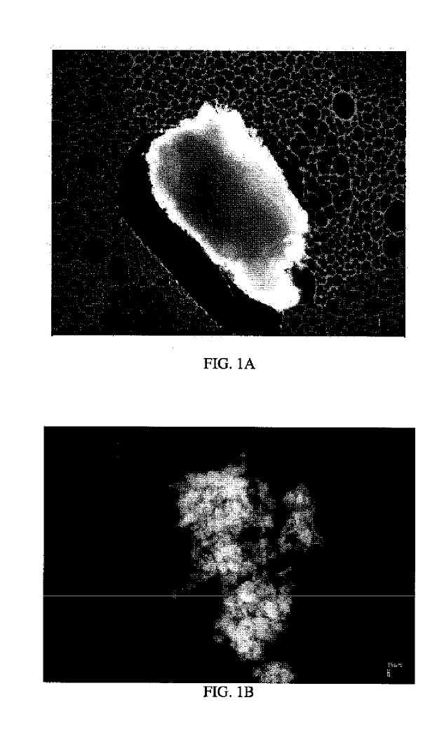

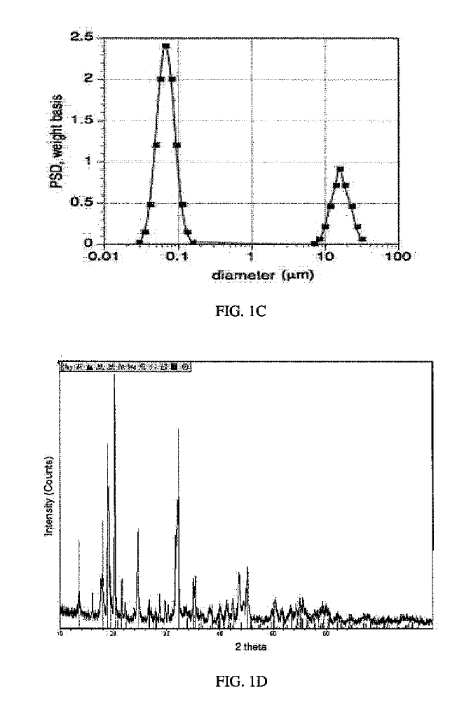

FIGS. 1A and 1B show respective SEM images of the conventional FePO₄ reaction product particle. FIG. 1C shows particle size distribution data of the conventional FePO₄ reaction product particle based on an acoustic particle size measurement technique. FIG. 1D shows an X-ray diffraction pattern of the conventional FePO₄ reaction product particle.

The BET surface area was measured as about 13 m²/g. The particle size distribution data indicates a bimodal particle distribution having a first peak at about 70 nm and a second peak at about 16 micron. When the iron phosphate is used as a precursor to form lithium iron phosphate reaction product particles, this bimodal distribution can lead to non-uniform synthesis of the lithium iron phosphate reaction product particles which can sacrifice electrical performance, amongst other problems.

### Example 2

This example illustrates characterization of an FePO₄ reaction product particle in accordance with an embodiment of the present invention and comparison to the conventional FePO₄ reaction product particle described in Example 1. Such a reaction product particle can be used as a precursor when forming lithium iron phosphate reaction product particles.

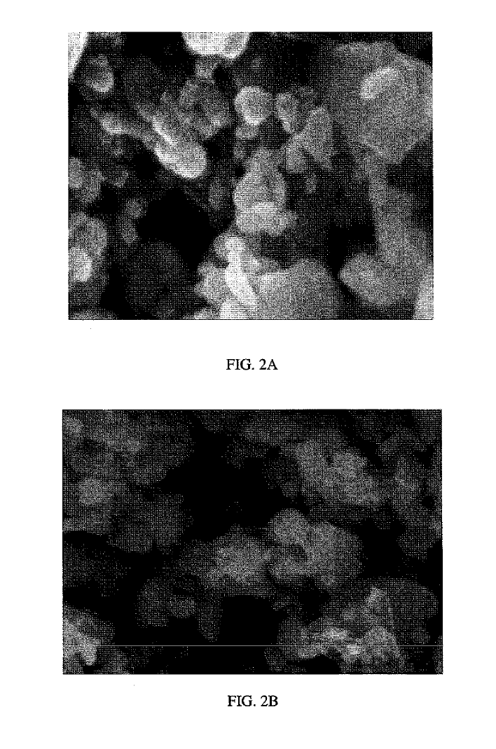

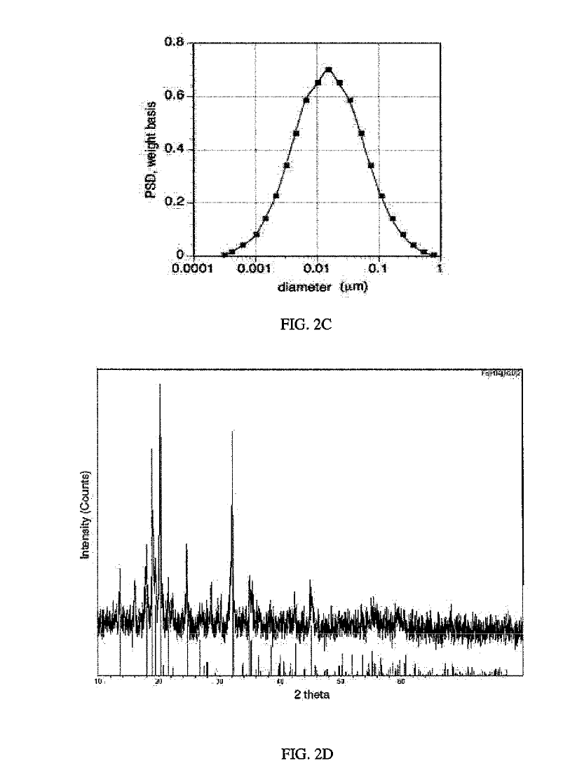

FePO₄ particles were milled using methods described above including grinding media comprising a multi-carbide material to produce nanosized FePO₄ particles. FIGS. 2A and 2B show respective SEM images of the FePO₄ reaction product particle. FIG. 2C shows particle size distribution data of the FePO₄ reaction product particle based on an acoustic particle size measurement technique. FIG. 2D shows an X-ray diffraction pattern of the FePO₄ reaction product particle.

The particle size distribution data indicates a unimodal particle distribution having a peak at about 30 nm. The particles exhibited a D10 value of 3.1 nm and a D90 value of 72.5 nm. The BET surface area was measured as about 142 m²/g. The XRD pattern established that the FePO₄ phase remained intact during processing.

Compared to the conventional FePO₄ reaction product particle described in Example 1, this reaction product particle exhibited improved characteristics. Significantly, a unimodal particle distribution was achieved which can significantly improve the consistency and properties of lithium iron phosphate reaction product particles made from the FePO₄ reaction product particles. Also, the D90 particle size was reduced from 16 microns to 72.5 nm (i.e., by a factor of about 220); and, the surface area of the particles was increased 10.9 times from 13 m²/g to 142 m²/g as compared to conventional FePO₄ reaction product particle described in Example 1.

### Example 3

This example illustrates production and characterization of a LiFePO₄ reaction product particle producing using a FePO₄ precursor reaction product particle similar to the one described in Example 2.

Milled FePO₄ particles similar to those produced in Example 2 were combined with the lithium carbonate particles, and a fluid carrier, and the mixture was milled to form a precursor blend, which was then removed from the mill and dried. The dry precursor blend was heated to a temperature of about 600-700° C. to form the LiFePO₄ reaction product particle by a solid state reaction between the FePO₄ precursor particles and the lithium carbonate precursor particles.

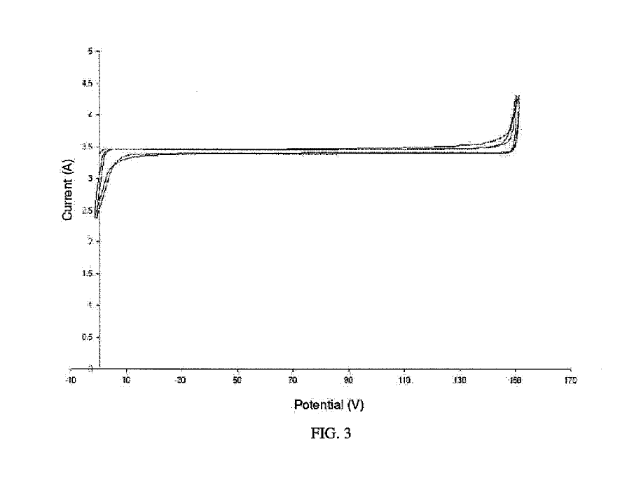

Electrical testing samples were made from the lithium iron phosphate reaction product particle. The cathode coating was around 20 mg/cm² of phosphate with 20% carbon and 10% binder. The electrochemical behavior was evaluated at a current density of 0.3 mA/cm² cycling between 2.4-4.3 volts. FIG. 3 shows the charge-discharge curves for the LiFePO₄ particles. The first three discharge capacities were observed to be around 150 mAh/g. Excellent cycling behavior was observed with low polarization (e.g., low voltage difference between charge and discharge curves), minimal or essentially no first cycle capacity loss, and a stable cycling capacity (e.g., around 150 mAh/g).

The results establish that lithium iron phosphate compositions according to an embodiment of the invention can provide excellent electrical properties.

### Example 4

The following example describes production and characterization of nano-sized layered lithium metal oxide reaction product particle according to an embodiment of the invention.

A 0.2Li₂MnO₃.0.8LiNi_{0.8}Co_{0.2}O₂ reaction product particle was prepared from precursor materials including MnO₂, Ni(OH)₂, Co(OH)₂, and LiOH.

MnO₂ particles were milled using methods described above including grinding media comprising a multi-carbide material to form nanosize particles having a particle size of about 60 nm. Ni(OH)₂, Co(OH)₂, and LiOH were then added to the milled MnO₂ particles, in combination with a fluid carrier, and milled to form a precursor blend, which was then dried and mildly ground. The dried precursor blend was then solid-state reacted in air at 300-500° C. for 3 hours, and then at 800-900° C. for 4.5 hours.

The resulting reaction product particle comprised 0.2Li₂MnO₃.0.8LiNi_{0.8}Co_{0.2}O₂ particles having a particle size of about 100-200 nm. As shown by the SEM images in FIGS. 4A-G, the reaction product particle included particles having uniform appearance with an equiaxed morphology. Movement of Li ions during the solid state reaction was expected to be enhanced, as the overall surface area of the particles was high and exhibited a preferred morphology. FIG. 4H shows an X-ray diffraction pattern of the reaction product particle, confirming the phase of the particles.

The small size and morphology of the lithium metal oxide particles can allow a more complete solid state reaction as well as a more homogeneous (e.g., uniform chemical and structural composition) product. The small size of the lithium metal oxide particles may also enable the solid state reaction to proceed at a lower temperature and a shorter time, resulting in a relatively faster production throughput. Methods such as this may substantially improve the electrochemical properties of lithium metal oxide reaction product particles, including increased capacity, improved thermal stability, and extended charge/discharge cycling lifetimes. The smaller size of lithium metal oxide particles may enhance lithium ion insertion and may improve safety.

### Example 5

The following example describes production and characterization of nano-sized layered lithium metal oxide reaction product particles. Three reaction product particles were prepared from precursor materials including MnO₂, Ni(OH)₂, Co(OH)₂, and Li₂CO₃ or LiOH, using the following general procedure.

MnO₂ particles were milled using methods described above including grinding media comprising a multi-carbide material to form nanosize particles having a particle size of about 80 nm. Ni(OH)₂, Co(OH)₂, and one of Li₂CO₃ or LiOH were then added to the milled MnO₂ particles, in combination with a fluid carrier, and milled to form a precursor blend, which was then dried and mildly ground. The dried precursor blend was then solid-state reacted in air at 300-500° C. for 3 hours, and then at 800-950° C. for 4.5 hours.

The resulting reaction product particles are shown in Table 1. Compositions A and B were synthesized using Li₂CO₃ as a precursor material. Composition A, 0.3 Li₂MnO₃.0.7 LiMn_{0.5}Ni_{0.5}, included particles having a particle size of about 100-250 nm with a block-like particle morphology and good packing density. Composition B, 0.1 Li₂MnO₃.0.9LiMn_{0.256}Ni_{0.372}Co_{0.372}O₂, included particles having a particle size of about 100-250 nm. The particles of Composition B exhibited a block-like morphology having slightly smoothed or rounded features and good packing density. Composition C, 0.2 Li₂MnO₃.0.8 LiNi_{0.8}Co_{0.2}O₂, was synthesized using LiOH as a precursor material, and included particles having a particle size of about 100-250 nm. Composition C also included particles having uniform appearance with an equiaxed morphology and high packing density.

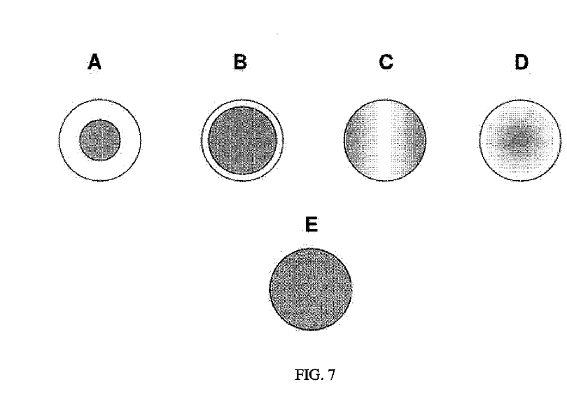

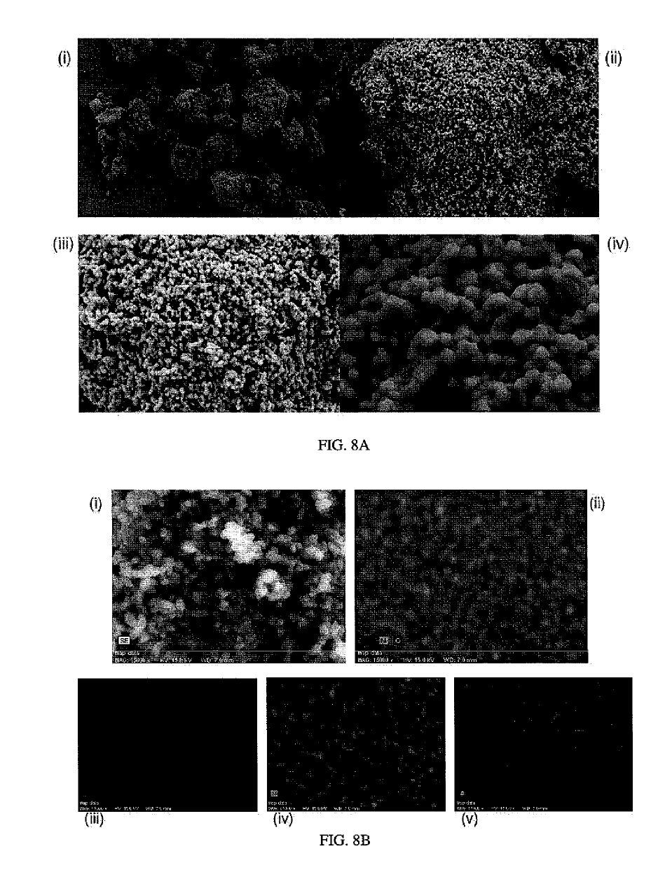

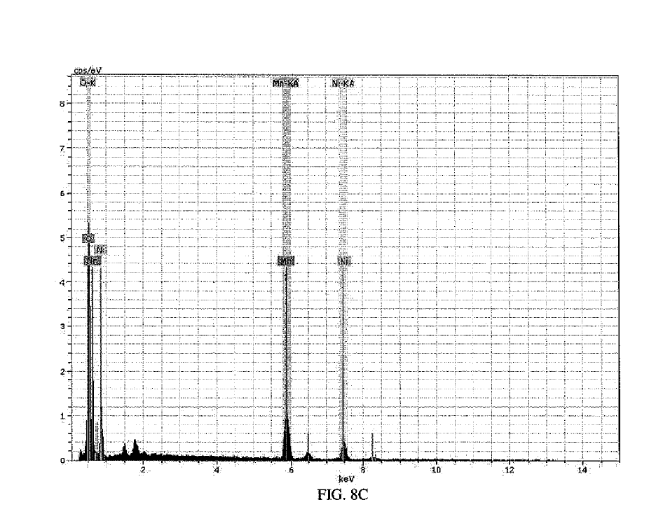

Mapping data and EDX spectra were measured for Composition A and Composition B. FIG. 8A shows SEM images of 0.3Li₂MnO₃.0.7LiMn_{0.5}Ni_{0.5}O₂ particles. FIG. 8B shows (i) an SEM image of 0.3Li₂MnO₃.0.7LiMn_{0.5}Ni_{0.5}O₂ particles; (ii) mapping data for the particles as in (i); (iii) mapping data for Mn atoms of the particles as in (i); (iv) mapping data for Ni atoms of the particles as in (i); and (v) mapping data for O atoms of the particles as in (i). FIG. 8C shows the EDX spectra for 0.3Li₂MnO₃.0.7LiMn_{0.5}Ni_{0.5}O₂ particles as described in Example 5. The particles were observed to have a substantially uniform composition.

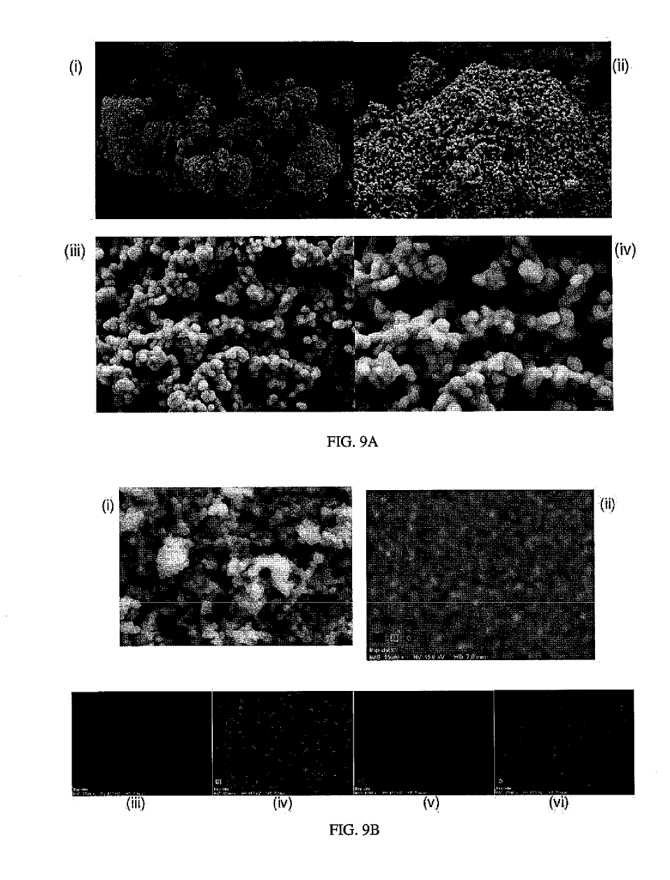

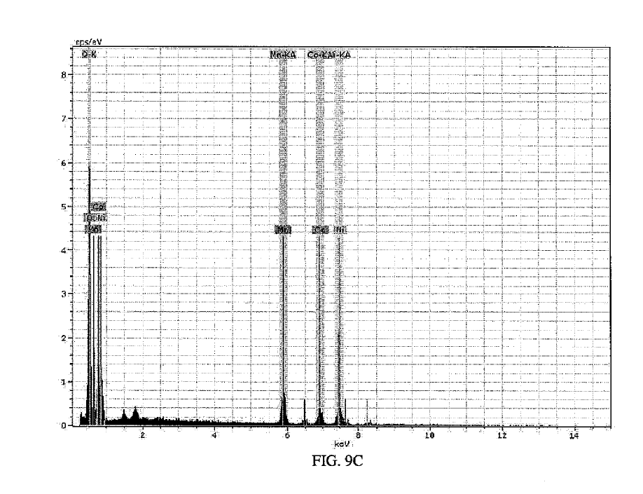

FIG. 9A shows SEM images of 0.1Li₂MnO₃.0.9LiMn_{0.256}Ni_{0.372}Co_{0.372}O₂ particles as described in Example 5. FIG. 9B shows (i) an SEM image of 0.1Li₂MnO₃.0.9LiMn_{0.256}Ni_{0.372}Co_{0.372}O₂ particles; (ii) mapping data for the particles as in (i); (iii) mapping data for Mn atoms of the particles as in (i); (iv) mapping data for Ni atoms of the particles as in (i); (v) mapping data for Co atoms of the particles as in (i); and (vi) mapping data for O atoms of the particles as in (i). FIG. 9C shows the EDX spectra for 0.1Li₂MnO₃.0.9LiMn_{0.256}Ni_{0.372}Co_{0.372}O₂ particles as described in Example 5. The particles were observed to have a substantially uniform composition.

TABLE 1
Precursor materials used in the synthesis of Compositions A-C.

| | Precursor Materials | | | | |
|---|---|---|---|---|---|
| Target composition | MnO₂ | Ni(OH)₂ | Co(OH)₂ | Li₂CO₃ | LiOH |
| Composition A: | x | x | | x | |
| 0.3Li₂MnO₃•0.7LiMn_{0.5}Ni_{0.5}O₂ | | | | | |
| Composition B: | x | x | x | x | |
| 0.1Li₂MnO₃•0.9LiMn_{0.256}Ni_{0.372}CO_{0.372}O₂ | | | | | |
| Composition C: | x | x | x | | x |
| 0.2Li₂MnO₃•0.8LiNi_{0.8}Co_{0.2}O₂ | | | | | |

### Example 6

The following example describes production and characterization of lithium iron phosphate reaction product particles.

A FePO₄.2H₂O precursor was split and divided into four samples A, B, C and D respectively. The samples had a bimodal particle size distribution from less than 100 nm to several microns with an average particle size of about 4 micron. The samples were processed as follows.

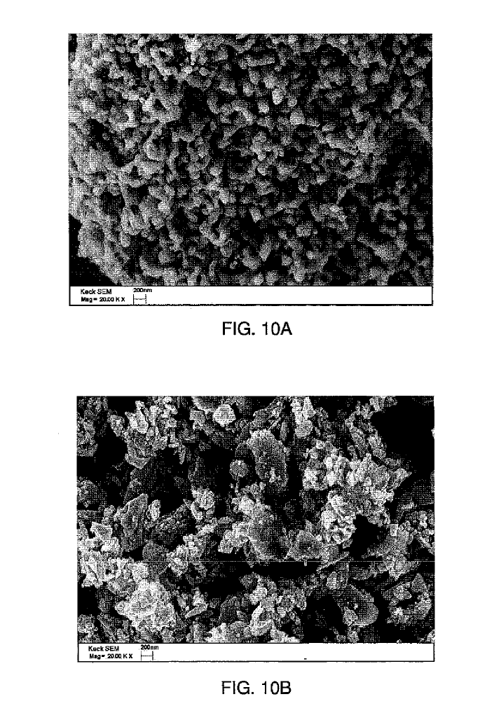

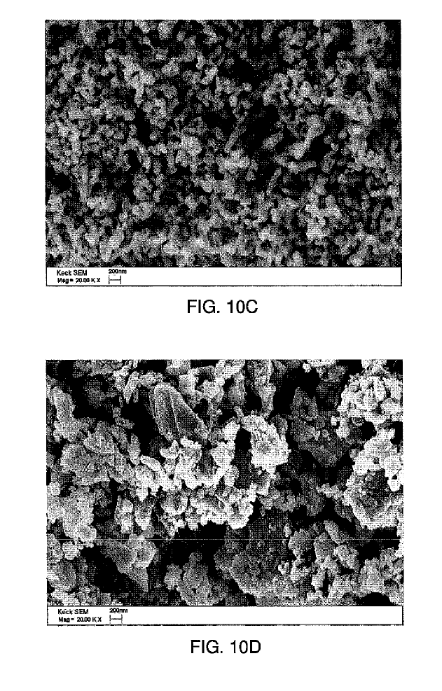

Sample A—80 gms of FePO₄.2H₂O was mixed with 650 gms of IPA, 1% by weight of Trioxadecanoic acid was used as a dispersant, the dispersant weight was based on solid FePO₄.2H₂O weight. The slurry was mixed using a stirrer followed by processing using a lab star milling apparatus from Netzsch using multi-carbide grinding media. The slurry was processed for a total of 66 min for a total energy of 45000 KJ/Kg. The final particle size of the FePO₄.2H₂O was 17 nm using DT1200, SEM confirmed the size. FIG. 10A shows the particles. The milled FePO₄.2H₂O was then blended with stoichiometric amounts of Li₂CO₃ and cellulose acetate using a Netzsch mill for 30 min.

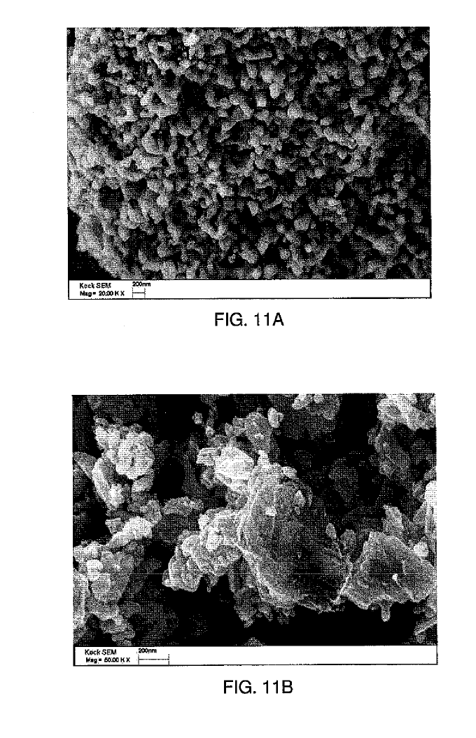

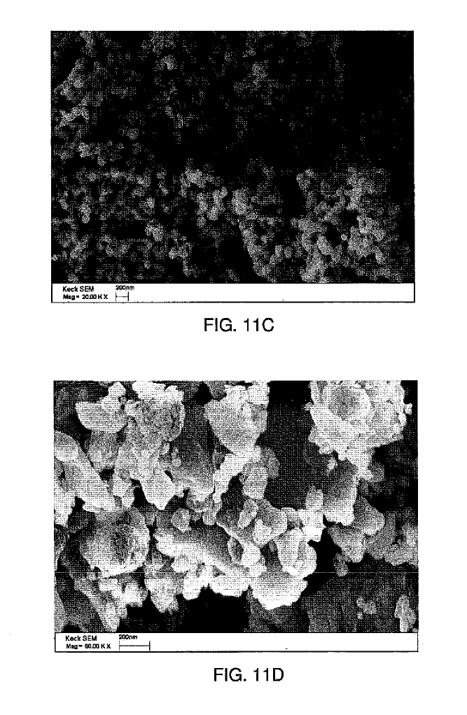

The slurry was later dried in a vacuum oven at ˜80 C and reacted in a furnace at 650 C for 2 hrs under reducing conditions using reforming gas to form lithium iron phosphate. SEM revealed the narrow particle size distribution of the lithium iron phosphate with an average particle size of about 100 nm as shown in FIG. 11A. XRD analysis confirmed the phase.

Sample B—The FePO₄.2H₂O particles (shown in FIG. 10B) were blended with stoichiometic amounts of Li₂CO₃ and cellulose acetate using a Netzsch mill for 30 min.

The slurry was later dried in a vacuum oven at 80 C and reacted in a furnace at 650 C for 2 hrs under reducing conditions using reforming gas to form lithium iron phosphate. SEM revealed a bimodal particle size distribution of the lithium iron phosphate as shown in FIG. 11B. XRD confirmed the phase.

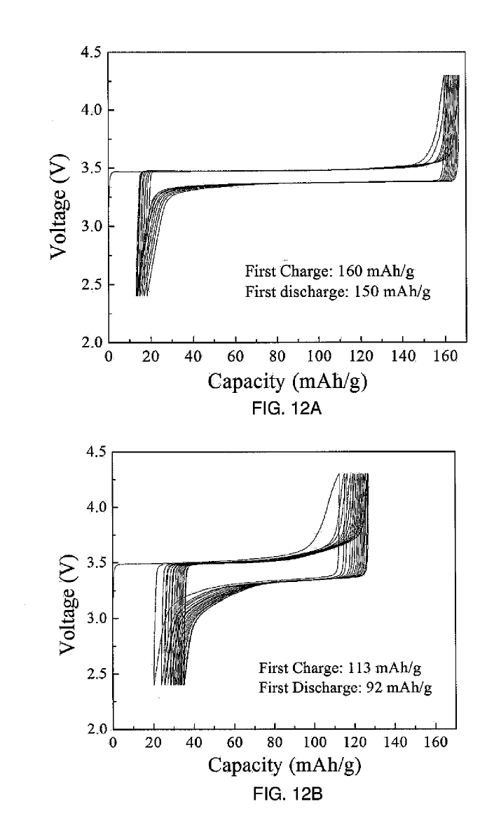

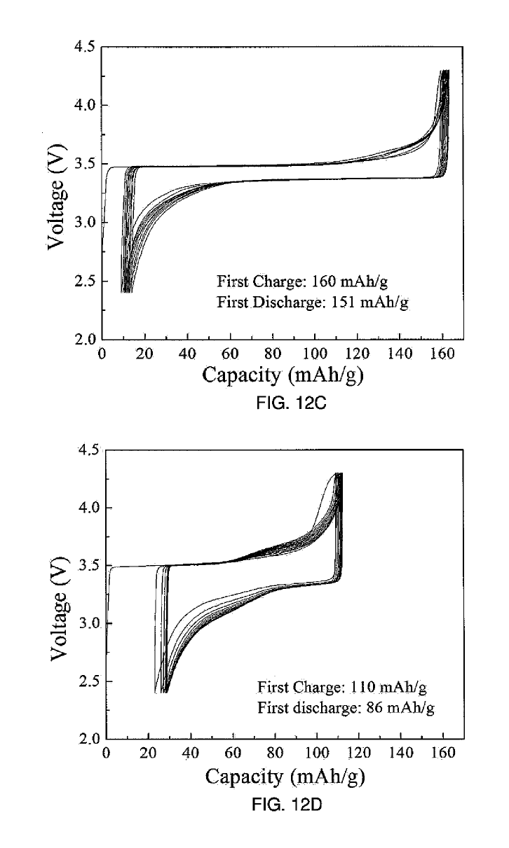

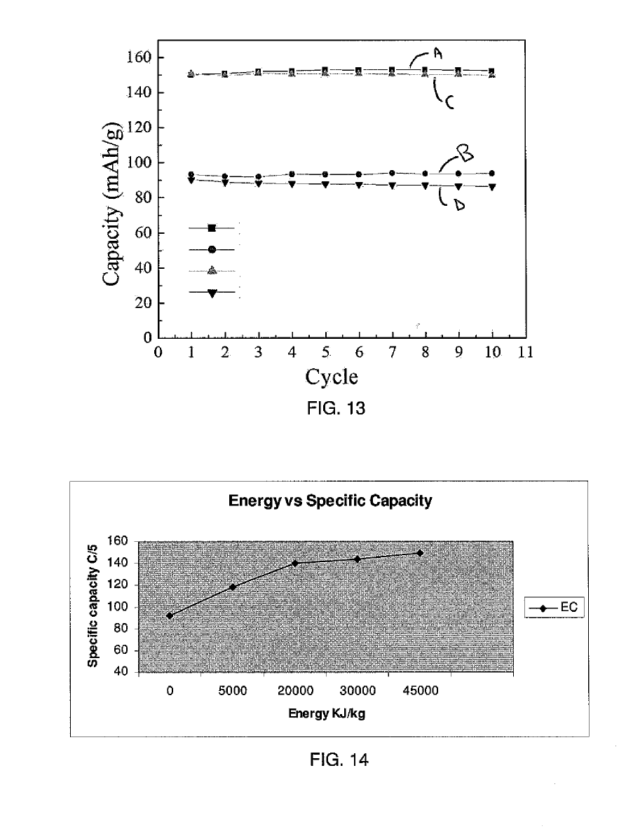

Sample C— The FePO₄.2H₂O particles were sieved through a 325 mesh screen. The powder from +325 mesh were collected. FIG. 10C shows the particles. This powder had a more bimodal distribution as compared to the FePO₄.2H₂O used in Sample A. The same procedure was then followed as described above for Sample A to produce lithium iron phosphate. SEM revealed an average particle size of about 100 nm as shown in FIG. 11C.
Sample D—The FePO₄.2H₂O particles were sieved through a 325 mesh screen. The powder from +325 mesh were collected. FIG. 10D shows the particles. The same procedure was then followed as described above for Sample B to produce lithium iron phosphate. SEM revealed a bimodal particle size distribution as shown in FIG. 11D.
Electrochemical Results—The lithium iron phosphate powders from Samples A-D were then tested for electrochemical properties using a button cell prepared using conventional techniques. The active material loading in each cathode was about 5-20 mg/cm². Capacity (mAh/g) versus Voltage (V) curves were obtained for each sample. The applied voltage ranged between 2.4 and 4.3 V at a C/5 rate at room temperature. FIGS. 12A-12D respectively show the CV curves for Samples A-D. FIG. 13 compares the cycling ability of the samples with Sample A being shown with rectangles; Sample B being shown with circles; Sample C being shown with triangles; and Sample D being shown with inverted triangles.
Conclusions: Samples A and C show excellent electrochemical performance. Their improved performance compared to Samples B and D are attributable to the step of milling the FePO₄.2H₂O precursor particles and the resulting particle sizes and morphology.

### Example 7

The following example describes production and characterization of lithium iron phosphate reaction product particles.

5 slurries were synthesized using 147 gms of FePO₄.2H₂O with 1330 gms of IPA, 1% by weight of Trioxadecanoic acid was used as a dispersant, the dispersant weight was based on solid FePO₄.2H₂O weight.

The slurries was processed for different times and thus different total milling energy levels in a lab star milling apparatus from Netzsch using multi-carbide grinding media. The specific energy varied from zero Kj/kg to 45000 KJ/Kg, the particle size or D50 for different slurries/particles varied from several microns to less than 20 nm, the D90 of the slurries varied from several micron to 84 nm for the 45000Kj/kg sample. All slurries processed to different energies were then blended with stoichiometic amounts of Li2CO3 and cellulose acetate using a Netzsch mill for 30 min. The slurries was later dried in a vacuum oven at ˜80 C and reacted in a furnace at 650 C for 2 hrs under reducing conditions using reforming gas to form lithium iron phosphate. The lithium iron phosphate powders from the samples were then tested for electrochemical properties using a button cell prepared using conventional techniques. Specific capacities were measured. FIG. 14 shows the specific capacity measurements at different energies. The trend shows an increased capacity with increasing energy. The higher capacities are believed to be attributable to small particle size resulting from the greater milling energies.

### Example 8

The following example describes production and characterization of nano-sized layered lithium metal oxide reaction product particles. Three reaction product particles were prepared from precursor materials including MnO₂, Ni(OH)₂, Co(OH)₂, and Li2CO₃ or LiOH, using the following general procedure.

MnO₂ particles were milled using methods described above including grinding media comprising a multi-carbide material to form nanosize particles having a particle size of about 80 nm. Ni(OH)₂, Co(OH)₂, and one of Li₂CO₃ or LiOH were then added to the milled MnO₂ particles, in combination with a fluid carrier, and milled to form a precursor blend, which was then dried and mildly ground. The dried precursor blend was then solid-state reacted in air at 300-500° C. for 3 hours, and then at 800-950° C. for 4 hours.

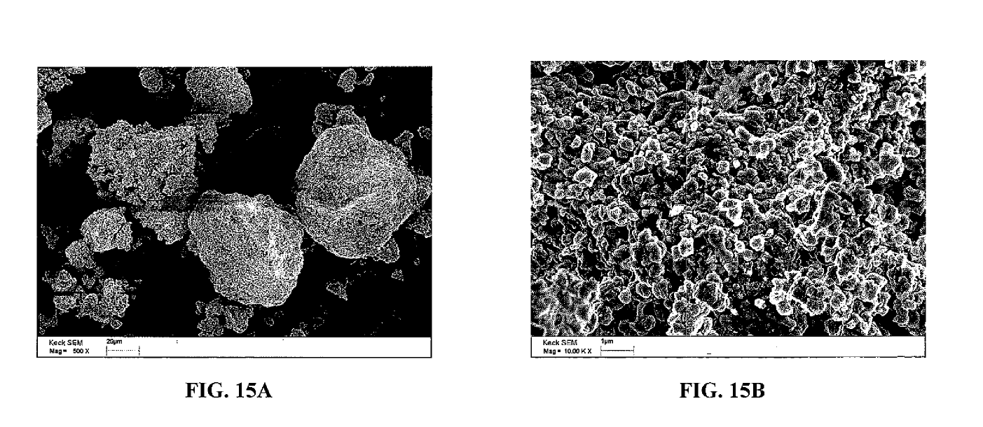

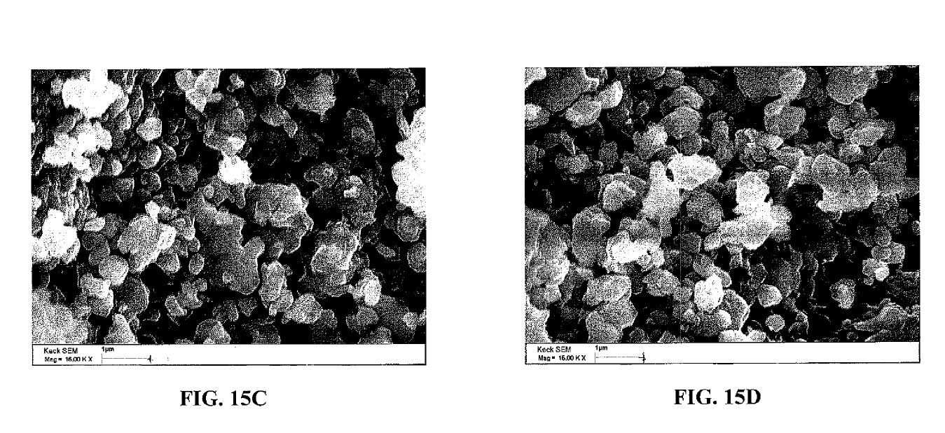

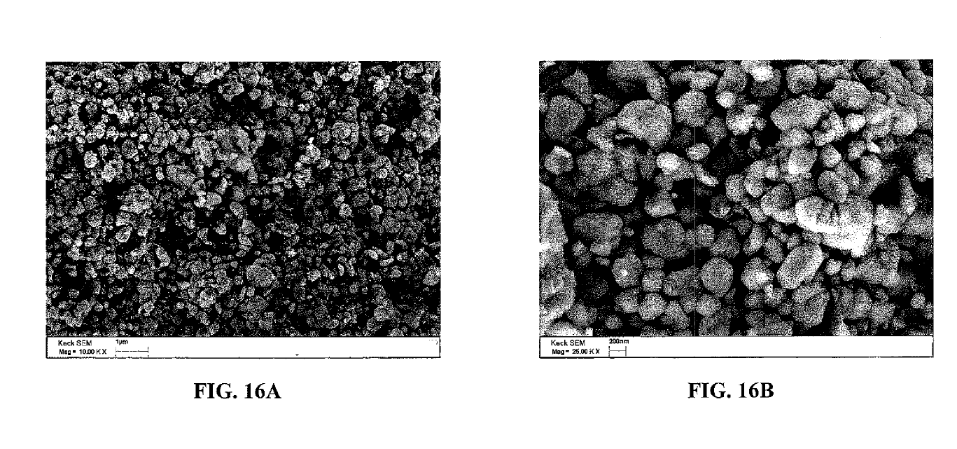

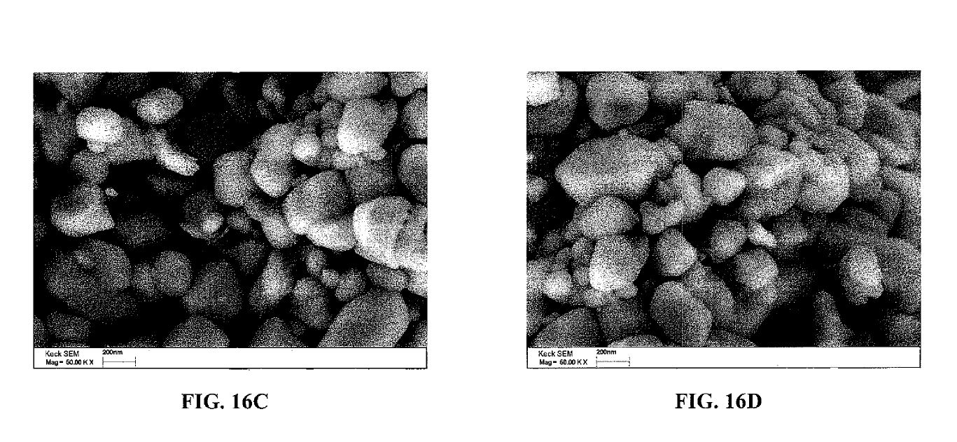

Sample D and E were synthesized using LiOH and Li2CO3 respectively as a precursor material. The final composition for both samples is 0.3LiMn2O3.0.7LiMn0.475Ni0.475Co0.1. Sample D included particles having a primary particle size of about 100-250 nm with a platelet particle morphology and good packing density. FIGS. 15A-15D are copies of micrographs showing the Sample D particles. Sample E included particles having a particle size of about 100-300 nm. FIGS. 16A-16D are copies of micrographs showing the Sample E particles. The particles of Sample E exhibited a block-like morphology having slightly smoothed or rounded features and good packing density.

Sample D (platelet morphology) demonstrated a higher specific capacity by 20-40% and stable cycling over its' counterpart, Sample E (blocky morphology).

### Example 9

This example illustrates the reaction characteristics for a LiFePO4 precursor blend prepared using a FePO4.2H2O precursor reaction product particle similar to the one described in Example 7. In addition, this example makes a comparison with a conventional bimodal LiFePO4 precursor blend.

Milled FePO4.2H2O particles similar to those produced in Example 7 were combined with the lithium carbonate particles, and a fluid carrier, and the mixture was milled to form a precursor blend, which was then removed from the mill and dried. The conventional bimodal LiFePO4 precursor blend was prepared by combining micron-sized bimodal FePO4.2H2O with the lithium carbonate particles, and a fluid carrier. This blend subsequently was dried in vacuum, the blending time was the same in both cases.

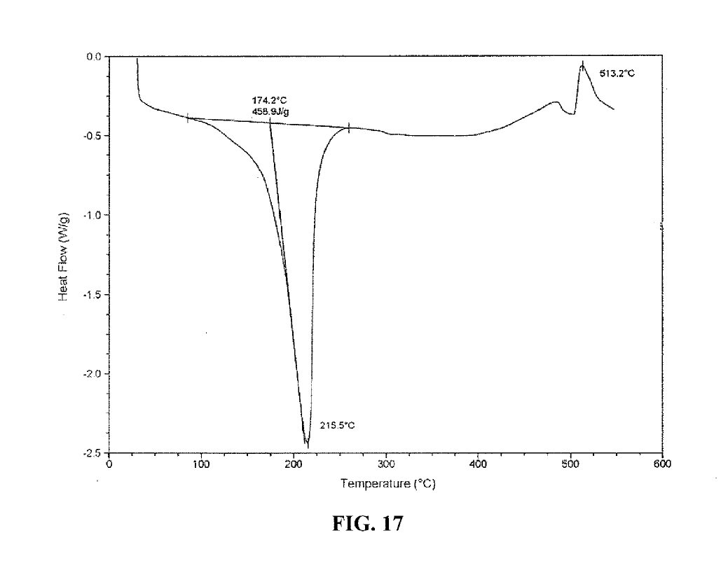

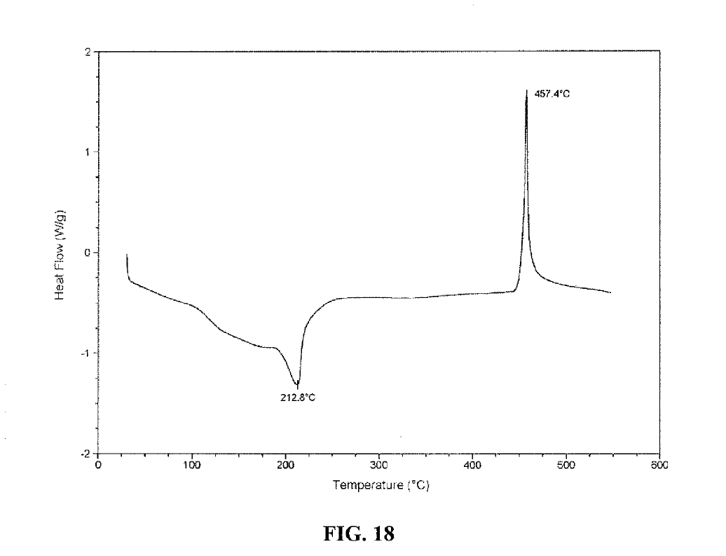

To examine the reaction characteristics DSC (Differential Scanning Calorimetry) analysis was used. For the analysis, a ramp rate of 10° C./min. and a 5% H2 in argon gas were used. The resulting reaction characteristics for the two samples (micron-sized as shown in FIG. 17 and nano-sized precursor as shown in FIG. 18) are substantially different. For example, the formation of LFP temperature using nanosized precursor (457.4° C.) is lower than for conventional precursor (513.2° C.), D=55.8° C. Secondly, the solid state reaction using nanosized precursor is sharper and higher than that using micron-sized precursor (bimodal and broader). This demonstrates that the reaction kinetics are faster, and there is better diffusion, better completeness of reaction over a substantially narrow temperature range, and more uniform reaction than the micron-sized precursor. The nano-sized precursor blend, the sharp reaction peaks illustrates that the majority of the particles are reacting instantly and at the same temperature. As a comparison, the micron-sized precursor blend reacts slower and less uniformly.

The results establish that a nano-sized precursor blend yields a lithium iron phosphate product that reacts rapidly and has excellent compositional uniformity.

Having thus described several aspects and embodiments of this invention, it is to be appreciated various alterations, modifications and improvements will readily occur to those skilled in the art. Such alterations, modifications and improvements are intended to be part of this disclosure, and are intended to be within the spirit and scope of the invention. Accordingly, the foregoing description and drawings are by way of example only.

What is claimed:

1. A method comprising:
providing a first precursor;
providing a second precursor; and
reacting the first precursor and the second precursor to form reaction product particles comprising an electrode material, wherein the average particle size of the reaction product particles is 500 nm or less and at least 50% of the reaction product particles have a composition that is substantially uniform throughout an individual reaction product particle.

2. The method of claim 1, wherein the first precursor is in the form of particles.

3. The method of claim 2, wherein the second precursor is in the form of particles.

4. The method of claim 2, further comprising milling at least the first precursor particles to form milled precursor particles prior to reacting.

5. The method of claim 1, wherein the milled precursor particles have an average particle size of less than 100 nm.

6. The method of claim 1, wherein the first precursor and the second precursor are milled together prior to reacting.

7. The method of claim 1, wherein at least 70% of the reaction product particles have a composition that is substantially uniform throughout an individual reaction product particle.

8. The method of claim 1, wherein at least 70% of the reaction product particles are substantially free of precursor material.

9. The method of claim 1, wherein the reacting comprises heating the mixture at a temperature of at least 500° C.

10. The method of claim 1, further comprising milling the reaction product particles.

11. The method of claim 1, wherein the reaction product particles have an average particle size of less than 100 nm.

12. The method of claim 1, wherein the electrode material is a lithium-based compound.

13. The method of claim 12, wherein the lithium-based compound is lithium iron phosphate.

14. The method of claim 1, wherein one of the precursors is aluminum nitrate, ammonium dihydrogen orthophosphate, ammonium monohydrogen orthophosphate, cobalt hydroxide, cobalt nitrate, cobalt oxide, iron acetate, iron oxide, iron phosphate, manganese acetate, manganese carbonate, manganese hydroxide, manganese oxide, nickel hydroxide, nickel nitrate, nickel oxide, or titanium oxide.

15. The method of claim 1, wherein one of the precursors is lithium carbonate, lithium acetate, lithium dihydrogen phosphate, lithium hydroxide, lithium nitrate, or lithium iodide.

16. The method of claim 1, wherein the reaction product particles have a layered structure.

17. The method of claim 1, wherein at least one of the precursors is provided at least partially dissolved in a fluid carrier.

18. The method of claim 1, wherein the first precursor in the form of particles having a platelet morphology.

19. The method of claim 1, further comprising forming an electrode from the reaction product particles.

20. A method, comprising:
providing a first precursor;
providing a second precursor; and
reacting the first precursor and the second precursor to form reaction product particles comprising an electrode material, wherein the average particle size of the reaction product particles is 500 nm or less and at least 50% of the reaction product particles are substantially free of precursor material.

21. The method of claim 20, wherein the first precursor is in the form of particles.

22. The method of claim 20, wherein the second precursor is in the form of particles.

23. The method of claim 20, further comprising milling at least the first precursor particles to form milled precursor particles prior to reacting.

24. The method of claim 23, wherein the milled precursor particles have an average particle size of less than 100 nm.

25. The method of claim 20, wherein the first precursor and the second precursor are milled together prior to reacting.

26. The method of claim 1, wherein at least 70% of the reaction product particles are substantially free of precursor material.

27. The method of claim 1, wherein the reacting comprises heating the mixture at a temperature of at least 500° C.

28. The method of claim 1, wherein the reaction product particles have an average particle size of less than 100 nm.

29. The method of claim 1, wherein the electrode material is a lithium-based compound.

30. The method of claim 29, wherein the lithium-based compound is lithium iron phosphate.

31. The method of claim 20, wherein the first precursor in the form of particles having a platelet morphology.

32. The method of claim 20, further comprising forming an electrode from the reaction product particles.

33. A method, comprising:
providing a first precursor;
providing a second precursor; and
reacting the first precursor and the second precursor to form reaction product particles comprising an electrode material, wherein the average particle size of the reaction product particles is 500 nm or less and at least 50% of the reaction product particles have the same chemical composition.

34. The method of claim 33, wherein the first precursor is in the form of particles.

35. The method of claim 33, wherein the second precursor is in the form of particles.

36. The method of claim 33, further comprising milling at least the first precursor particles to form milled precursor particles prior to reacting.

37. The method of claim 33, wherein the milled precursor particles have an average particle size of less than 100 nm.

38. The method of claim 33, wherein the first precursor and the second precursor are milled together prior to reacting.

39. The method of claim 33, wherein at least 50% of the reaction product particles have the same chemical composition.

40. The method of claim 33, wherein the reaction product particles have an average particle size of less than 100 nm.

41. The method of claim 33, wherein the electrode material is a lithium-based compound.

42. The method of claim 41, wherein the lithium-based compound is lithium iron phosphate.

43. The method of claim 33, wherein the first precursor in the form of particles having a platelet morphology.

44. The method of claim 33, further comprising forming an electrode from the reaction product particles.

45. An electrode composition, comprising:
reaction product particles comprising an electrode material, wherein the average particle size of the reaction product particles is 500 nm or less and at least 50% of the reaction product particles have a composition that is substantially uniform throughout an individual reaction product particle.

46. The electrode composition of claim 45, wherein the average particle size of the reaction product is less than 100 nm.

47. The electrode composition of claim 45, wherein the electrode material is a lithium-based compound.

48. A device comprising the electrode composition of claim 45.

49. An electrode composition, comprising:
reaction product particles comprising an electrode material, wherein the average particle size of the reaction product particles is 500 nm or less and at least 50% of the reaction product particles are substantially free of precursor material.

50. The electrode composition of claim 49, wherein the average particle size of the reaction product is less than 100 nm.

51. The electrode composition of claim 49, wherein the electrode material is a lithium-based compound.

52. A electrode composition, comprising:
reaction product particles comprising an electrode material, wherein the average particle size of the reaction product particles is 500 nm and at least 50% of the reaction product particles have the same chemical composition.

53. The electrode composition of claim 52, wherein the average particle size of the reaction product is less than 100 nm.

54. The electrode composition of claim 52, wherein the electrode material is a lithium-based compound.
